(19) United States
(12) Patent Application Publication
(10) Pub. No.: US 2014/0064373 A1
(43) Pub. Date: Mar. 6, 2014

(54) METHOD AND DEVICE FOR PROCESSING PREDICTION INFORMATION FOR ENCODING OR DECODING AT LEAST PART OF AN IMAGE

(71) Applicant: CANON KABUSHIKI KAISHA, Tokyo (JP)

(72) Inventors: Fabrice LE LEANNEC, MOUAZE (FR); Sébastien LASSERRE, RENNES (FR)

(73) Assignee: CANON KABUSHIKI KAISHA, Tokyo (JP)

(21) Appl. No.: 14/011,592

(22) Filed: Aug. 27, 2013

(30) Foreign Application Priority Data
Aug. 30, 2012 (GB) 1215430.8
Sep. 28, 2012 (GB) 1217452.0

(51) Int. Cl. H04N 7/26; H04N 7/32

(52) U.S. Cl. CPC H04N 19/00424; H04N 19/00569
USPC 375/240.16; 375/240.12

(57) ABSTRACT

An aspect of the invention provides a method of processing prediction information for at least part of an image of an enhancement layer of video data, the video data including the enhancement layer and a base layer of lower quality, the enhancement layer being composed of processing blocks and the base layer being composed of elementary units, the method comprising: deriving, for processing blocks of the enhancement layer, prediction information from prediction information of one or more spatially corresponding elementary units of the base layer; constructing a prediction image corresponding to the enhancement image, and the prediction image being composed of prediction units, each processing block of the enhancement layer corresponding spatially to at least one prediction unit of the prediction image, wherein each prediction unit is predicted by applying a prediction mode using the prediction information derived from the base layer.

This application claims the benefit under 35 U.S.C. §119(a)-(d) of United Kingdom Patent Application No. 1215430.8, filed on Aug. 30, 2012 and entitled “Method and device for determining prediction information for encoding or decoding at least part of an image” and of United Kingdom Patent Application No. 1217452.0, filed on Sep. 28, 2012 and entitled “Method and device for processing prediction information for encoding or decoding at least part of an image”. The above cited patent applications are incorporated herein by reference in their entirety.

The present invention concerns a method and device for processing prediction information for encoding or decoding at least part of an image. The present invention further concerns a method and a device for encoding at least part of an image and a method and device for decoding at least part of an image.

Embodiments of the invention relate to the field of scalable video coding, in particular to scalable video coding in which the High Efficiency Video Coding (HEVC) standard may be applied.

### BACKGROUND OF THE INVENTION

Video data is typically composed of a series of still images which are shown rapidly in succession as a video sequence to give the idea of a moving image. Video applications are continuously moving towards higher and higher resolution. A large quantity of video material is distributed in digital form over broadcast channels, digital networks and packaged media, with a continuous evolution towards higher quality and resolution (e.g. higher number of pixels per frame, higher frame rate, higher bit-depth or extended colour gamut). This technological evolution puts higher pressure on the distribution networks that are already facing difficulties in bringing HDTV resolution and high data rates economically to the end user.

Video coding techniques typically use spatial and temporal redundancies of images in order to generate data bit streams of reduced size compared with the video sequences. Spatial prediction techniques (also referred to as Intra coding) exploit the mutual correlation between neighbouring image pixels, while temporal prediction techniques (also referred to as INTER coding) exploit the correlation between images of sequential images. Such compression techniques render the transmission and/or storage of the video sequences more effective since they reduce the capacity required of a transfer network, or storage device, to transmit or store the bit-stream code.

An original video sequence to be encoded or decoded generally comprises a succession of digital images which may be represented by one or more matrices the coefficients of which represent pixels. An encoding device is used to code the video images, with an associated decoding device being available to reconstruct the bit stream for display and viewing.

Common standardized approaches have been adopted for the format and method of the coding process. One of the more recent standards is Scalable Video Coding (SVC) in which a video image is split into smaller sections (often referred to as macroblocks or blocks) and treated as being comprised of hierarchical layers. The hierarchical layers include a base layer, corresponding to lower quality images (or frames) of the original video sequence, and one or more enhancement layers (also known as refinement layers) providing better quality, spatial and/or temporal enhancement images compared to base layer images. SVC is a scalable extension of the H.264/AVC video compression standard. In SVC, compression efficiency can be obtained by exploiting the redundancy between the base layer and the enhancement layers.

A further video standard being standardized is HEVC, in which the macroblocks are replaced by so-called Coding Units and are partitioned and adjusted according to the characteristics of the original image segment under consideration. This allows more detailed coding of areas of the video image which contain relatively more information and less coding effort for those areas with fewer features.

In general, the more information that can be compressed at a given visual quality, the better the performance in terms of compression efficiency.

The present invention has been devised to address one or more of the foregoing concerns.

### SUMMARY OF THE INVENTION

According to a first aspect of the invention there is provided a method of processing prediction information for at least part of an image of an enhancement layer of video data, the video data including the enhancement layer and a base layer of lower quality, the enhancement layer being composed of processing blocks and the base layer being composed of elementary units, the method comprising

deriving, for processing blocks of the enhancement layer, prediction information from prediction information of one or more spatially corresponding elementary units of the base layer;

constructing a prediction image corresponding to the enhancement image,

the prediction image being composed of prediction units, each processing block of the enhancement layer corresponding spatially to at least one prediction unit of the prediction image, wherein each prediction unit is predicted by applying a prediction mode using the prediction information derived from the base layer.

In an embodiment the method includes applying de-blocking filtering to the constructed prediction image.

In an embodiment the de-blocking filtering is applied to the boundaries of the prediction units of the prediction image.

In an embodiment the method includes deriving the organisation of transform units of the elementary units in the base layer towards the enhancement layer wherein the de-blocking filtering is applied to the boundaries of the transform units derived from the base layer.

In an embodiment in the case where the elementary unit of the base layer corresponding to the processing block considered is Inter-coded then the prediction unit of the prediction image is temporally predicted using motion information derived from the said corresponding elementary unit of the base layer.

In an embodiment the prediction unit is temporally predicted further using temporal residual information from the corresponding elementary unit of the base layer.

In an embodiment the temporal residual information from the corresponding elementary prediction of the base layer corresponds to the decoded temporal residual of the elementary unit of the base layer.

In an embodiment the residual of the base prediction unit is computed between base layer images, as a function of the motion information of the base prediction unit.

In an embodiment the prediction information for a prediction unit is derived from at least one elementary unit of the base layer corresponding to the processing block of the enhancement layer.

In an embodiment the method includes determining whether or not the region of the base layer, spatially corresponding to the processing block, is fully located within one elementary unit of the base layer; and

in the case where the region of the base layer spatially corresponding to the processing block is fully located within one elementary unit of the base layer, deriving prediction information for that processing block from the base layer prediction information of the said one elementary unit;

otherwise in the case where the region of the base layer spatially corresponding to the processing block overlaps, at least partially, each of a plurality of elementary units,
dividing the processing block into a plurality of sub-processing blocks, each of size N×N such that the region of the base layer spatially corresponding to each sub-processing block is wholly located within one elementary prediction unit of the base layer; and
deriving the prediction information for each sub-processing block from the base layer prediction information of the spatially corresponding elementary unit.

In another embodiment the method includes determining whether or not the region of the base layer, spatially corresponding to the processing block, is fully located within one elementary unit of the base layer; and

in the case where a region of the base layer, spatially corresponding to the processing block, is fully located within one elementary unit, the prediction information for the processing block is derived from the base layer prediction information of said one elementary unit;

otherwise, in the case where a plurality of elementary units are at least partially located in the region of the base layer spatially corresponding to the processing block, the prediction information for the processing block is derived from the base layer prediction information of one of said elementary unit, selected according to the relative location of said one of said plurality of elementary units with respect to the other elementary units of said plurality of elementary units.

In another embodiment the method includes determining whether or not the region of the base layer, spatially corresponding to the processing block, is fully located within one elementary unit of the base layer; and

in the case where a region of the base layer, spatially corresponding to the processing block, is fully located within one elementary unit, the prediction information for the processing block is derived from the base layer prediction information of said one elementary unit;

otherwise, in the case where a plurality of elementary units are at least partially located in the region of the base layer spatially corresponding to the processing block, the prediction information for the processing block is derived from the base layer prediction information of one of said elementary unit, selected such that the prediction information of the elementary unit providing the best diversity among motion information values associated with the said processing block is selected.

A second aspect of the invention provides a method of encoding an enhancement image composed of processing blocks wherein each processing block is composed of at least one enhancement prediction unit, each enhancement prediction unit being predicted according to a prediction mode, from among a plurality of prediction modes including a prediction mode comprising predicting the texture data of the considered enhancement prediction unit from its co-located area within the prediction image constructed in accordance with any embodiment of the first aspect

A third aspect of the invention provides a method of decoding an enhancement image composed of processing blocks wherein each processing block is composed of at least one enhancement prediction unit, each enhancement prediction unit being predicted according to a prediction mode, from among a plurality of prediction modes, said prediction mode being signalled in the coded video bit-stream, one of said plurality of prediction modes comprising predicting the texture data of the considered enhancement prediction unit from its co-located area within the prediction image constructed in accordance with any embodiment of the first aspect of the invention.

In an embodiment the plurality of prediction modes further includes a motion compensated temporal prediction mode, for temporally predicting the enhancement prediction unit from a reference image of the enhancement layer.

In an embodiment the plurality of prediction modes further includes an interlayer prediction mode in which the enhancement prediction unit is predicted from a spatially corresponding region of reconstructed elementary units of the base layer.

In an embodiment in the case where the corresponding elementary unit of the base layer is Intra-coded then the enhancement prediction unit is predicted from the elementary unit reconstructed and resampled to the enhancement layer resolution

In an embodiment in the case of spatial scalability between the base layer and the enhancement layer, the prediction information is up-sampled from a level corresponding to the spatial resolution of the base layer to a level corresponding to the spatial resolution of the enhancement layer.

A fourth aspect of the invention provides a device for processing prediction information for at least part of an image of an enhancement layer of video data, the video data including the enhancement layer and a base layer of lower quality, the enhancement layer being composed of processing blocks and the base layer being composed of elementary units, the device comprising

a prediction information derivation module for deriving, for processing blocks of the enhancement layer, prediction information from prediction information of one or more spatially corresponding elementary units of the base layer;

an image construction module for constructing a prediction image corresponding to the enhancement image,

the prediction image being composed of prediction units, each processing block of the enhancement layer corresponding spatially to at least one prediction unit of the prediction image, wherein the image construction module is operable to prediction each prediction unit by applying a prediction mode using the prediction information derived from the base layer.

In an embodiment a de-blocking filtering module is provided for deblock filtering the constructed prediction image.

In an embodiment the de-blocking filtering module is operable to apply de-blocking filtering to the boundaries of the prediction units of the prediction image.

In an embodiment a derivation unit is provided for deriving the organisation of transform units of the elementary units in the base layer towards the enhancement layer and wherein the de-blocking filtering module is operable to apply de-blocking filtering to the boundaries of the transform units derived from the base layer.

In an embodiment in the case where the elementary unit of the base layer corresponding to the processing block considered is Inter-coded then the image construction module is operable to predict the prediction unit of the prediction image using motion information derived from the said corresponding elementary unit of the base layer.

In an embodiment the image construction module is operable to temporally predict the prediction unit using temporal residual information from the corresponding elementary unit of the base layer.

In an embodiment the temporal residual information from the corresponding elementary prediction of the base layer corresponds to the decoded temporal residual of the elementary unit of the base layer.

In an embodiment the residual of the base prediction unit is computed between base layer images, as a function of the motion information of the base prediction unit.

In an embodiment the prediction information derivation module is operable to derive the prediction information for a prediction unit from at least one elementary unit of the base layer corresponding to the processing block of the enhancement layer.

In an embodiment the prediction information derivation module is operable to determine whether or not the region of the base layer, spatially corresponding to the processing block, is fully located within one elementary unit of the base layer; and

in the case where the region of the base layer spatially corresponding to the processing block is fully located within one elementary unit of the base layer, to derive prediction information for that processing block from the base layer prediction information of the said one elementary unit;

otherwise in the case where the region of the base layer spatially corresponding to the processing block overlaps, at least partially, each of a plurality of elementary units,
to divide the processing block into a plurality of sub-processing blocks, each of size N×N such that the region of the base layer spatially corresponding to each sub-processing block is wholly located within one elementary prediction unit of the base layer; and
to derive the prediction information for each sub-processing block from the base layer prediction information of the spatially corresponding elementary unit.

In an embodiment the prediction information derivation module is operable to determine whether or not the region of the base layer, spatially corresponding to the processing block, is fully located within one elementary unit of the base layer; and

in the case where a region of the base layer, spatially corresponding to the processing block, is fully located within one elementary unit, to derive the prediction information for the processing block from the base layer prediction information of said one elementary unit;

otherwise, in the case where a plurality of elementary units are at least partially located in the region of the base layer spatially corresponding to the processing block, to derive the prediction information for the processing block from the base layer prediction information of one of said elementary unit, selected according to the relative location of said one of said plurality of elementary units with respect to the other elementary units of said plurality of elementary units.

In an embodiment the prediction information derivation module is operable to determine whether or not the region of the base layer, spatially corresponding to the processing block, is fully located within one elementary unit of the base layer; and

in the case where a region of the base layer, spatially corresponding to the processing block, is fully located within one elementary unit, to derive the prediction information for the processing block from the base layer prediction information of said one elementary unit;

otherwise, in the case where a plurality of elementary units are at least partially located in the region of the base layer spatially corresponding to the processing block, to derive the prediction information for the processing block from the base layer prediction information of one of said elementary unit, selected such that the prediction information of the elementary unit providing the best diversity among motion information values associated with the said processing block is selected.

A further aspect of the invention provides an encoding device for encoding an enhancement image composed of processing blocks wherein each processing block is composed of at least one enhancement prediction unit, the device comprising

a device according to any embodiment of the fourth aspect of the invention for constructing a prediction image; and

an encoder for predicting each enhancement prediction unit according to a prediction mode, from among a plurality of prediction modes including a prediction mode comprising predicting the texture data of the considered enhancement prediction unit from its co-located area within the constructed prediction image constructed by the said device.

A yet further aspect of the invention provides a decoding device for decoding an enhancement image composed of processing blocks wherein each processing block is composed of at least one enhancement prediction unit,

a device according to any one of claims 19 to 30 for constructing a prediction image; and

a decoder for predicting each enhancement prediction unit according to a prediction mode, from among a plurality of prediction modes, said prediction mode being signalled in the coded video bit-stream, one of said plurality of prediction modes comprising predicting the texture data of the considered enhancement prediction unit from its co-located area within the prediction image constructed by the said device.

In an embodiment the plurality of prediction modes further includes a motion compensated temporal prediction mode, for temporally predicting the enhancement prediction unit from a reference image of the enhancement layer.

In an embodiment the plurality of prediction modes further includes an interlayer prediction mode in which the enhancement prediction unit is predicted from a spatially corresponding region of reconstructed elementary units of the base layer.

In an embodiment in the case where the corresponding elementary unit of the base layer is Intra-coded then the enhancement prediction unit is predicted from the elementary unit reconstructed and resampled to the enhancement layer resolution

In an embodiment in the case of spatial scalability between the base layer and the enhancement layer, the prediction information is up-sampled from a level corresponding to the spatial resolution of the base layer to a level corresponding to the spatial resolution of the enhancement layer.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

Embodiments of the invention will now be described, by way of example only, and with reference to the following drawings in which:—

### BRIEF DESCRIPTION OF THE DRAWINGS

Embodiments of the invention will now be described, by way of example only, and with reference to the following drawings in which:

FIG. 1A schematically illustrates a data communication system in which one or more embodiments of the invention may be implemented;

FIG. 1B is a schematic block diagram illustrating a processing device configured to implement at least one embodiment of the present invention;

FIG. 2 illustrates an example of an all-INTRA configuration for scalable video coding (SVC);

FIG. 3A illustrates an exemplary scalable video encoder architecture in all-INTRA mode;

FIG. 3B illustrates an exemplary scalable video decoder architecture, associated with the scalable video encoder architecture for all-INTRA mode (as shown in FIG. 3A);

FIG. 4A schematically illustrates an exemplary random access temporal coding structure according to the HEVC standard;

FIG. 4B schematically illustrates elementary prediction units and prediction unit concepts specified in the HEVC standard;

FIG. 5 is a block diagram of a scalable video encoder according to an embodiment of the invention;

FIG. 6 is a block diagram of a scalable video decoder according to an embodiment of the invention;

FIG. 7A schematically illustrates prediction information up-sampling according to an embodiment of the invention in the case of dyadic spatial scalability;

FIG. 7B schematically illustrates prediction information up-sampling according to an embodiment of the invention in the case of a non-integer scaling ratio;

FIG. 8A schematically illustrates prediction modes suitable for scalable codec architecture, according to an embodiment of the invention;

FIG. 8B schematically illustrates inter-layer derivation of prediction information for 4×4 enhancement layer blocks in accordance with an embodiment of the invention;

FIG. 9 schematically illustrates derivation of prediction units of the enhancement layer in accordance with an embodiment of the invention;

FIG. 10 is a flowchart illustrating steps of a method of deriving prediction information in accordance with an embodiment of the invention;

FIG. 11 is a flowchart illustrating steps of a method of deriving prediction information in accordance with an embodiment of the invention;

FIG. 12 schematically illustrates the construction of a Base Mode prediction picture according to an embodiment of the invention;

FIG. 13 schematically illustrates a method of deriving a transform tree from a base layer to an enhancement layer in accordance with an embodiment of the invention;

FIGS. 14A and 14B schematically illustrate transform tree interlayer derivation in the case of dyadic spatial scalability in accordance with an embodiment of the invention;

FIG. 15A is flow chart illustrating steps of a method for image coding in accordance with one or more embodiments of the invention;

FIG. 15B is flow chart illustrating steps of a method for image decoding in accordance with one or more embodiments of the invention;

FIG. 16 is flow chart illustrating steps of a method for computing a prediction image in accordance with one or more embodiments of the invention;

FIG. 17A schematically illustrates a method of inter-layer prediction of residual data in accordance with an embodiment of the invention;

FIG. 17B illustrates a method of inter-layer prediction of residual data for encoding in accordance with an embodiment of the invention;

FIG. 17C illustrates a method of residual prediction for encoding in accordance with an embodiment of the invention; and

FIG. 18 schematically illustrates processing of a base mode prediction image in accordance with an embodiment of the invention

### DETAILED DESCRIPTION OF EMBODIMENTS OF THE INVENTION

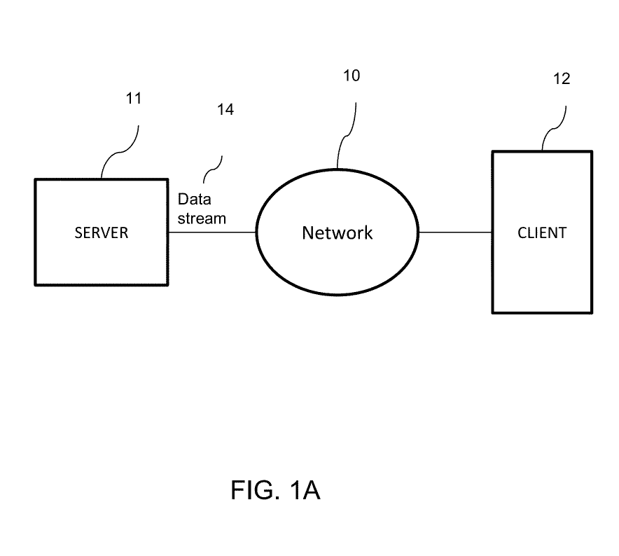

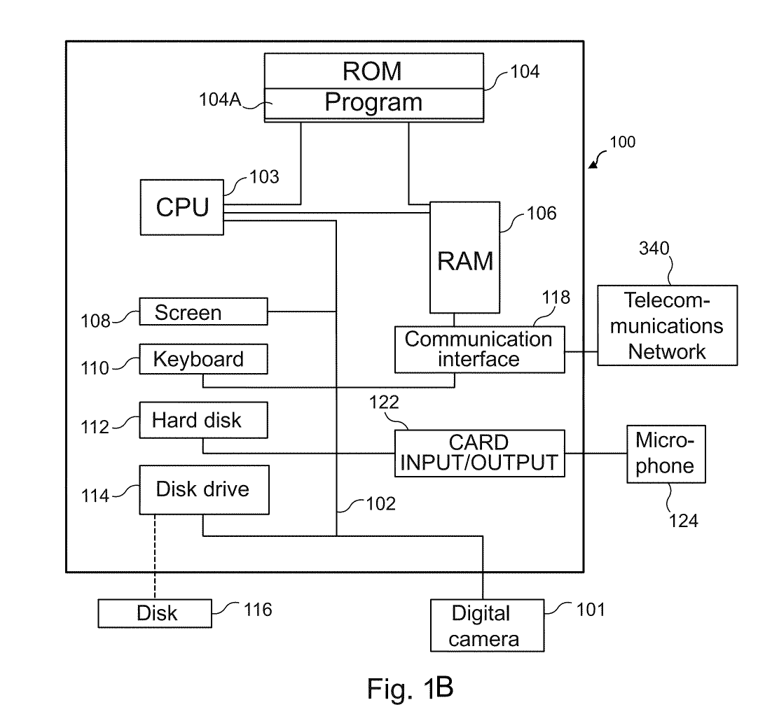

FIG. 1A illustrates a data communication system in which one or more embodiments of the invention may be implemented. The data communication system comprises a sending device, in this case a server 11, which is operable to transmit data packets of a data stream to a receiving device, in this case a client terminal 12, via a data communication network 10. The data communication network 10 may be a Wide Area Network (WAN) or a Local Area Network (LAN). Such a network may be for example a wireless network (Wifi/802.11a or b or g or n), an Ethernet network, an Internet network or a mixed network composed of several different networks. In a particular embodiment of the invention the data communication system may be, for example, a digital television broadcast system in which the server 11 sends the same data content to multiple clients.

The data stream 14 provided by the server 11 may be composed of multimedia data representing video and audio data. Audio and video data streams may, in some embodiments, be captured by the server 11 using a microphone and a camera respectively. In some embodiments data streams may be stored on the server 11 or received by the server 11 from another data provider. The video and audio streams are coded by an encoder of the server 11 in particular for them to be compressed for transmission.

In order to obtain a better ratio of the quality of transmitted data to quantity of transmitted data, the compression of the video data may be of motion compensation type, for example in accordance with the HEVC type format or H.264/AVC type format.

A decoder of the client 12 decodes the reconstructed data stream received by the network 10. The reconstructed images may be displayed by a display device and received audio data may be reproduced by a loud speaker.

FIG. 1B schematically illustrates a device 100, in which one or more embodiments of the invention may be implemented. The exemplary device as illustrated is arranged in cooperation with a digital camera 101, a microphone 124 connected to a card input/output 122, a telecommunications network 340 and a disk 116. The device 100 includes a communication bus 102 to which are connected:
a central processing CPU 103 provided, for example in the form of a microprocessor
a read only memory (ROM) 104 comprising a computer program 104A whose execution enables methods according to one or more embodiments of the invention to be performed. This memory 104 may be a flash memory or EEPROM, for example;
a random access memory (RAM) 106 which, after powering up of the device 100, contains the executable code of the program 104A necessary for the implementation of one or more embodiments of the invention. The memory 106, being of a random access type, provides more rapid access compared to ROM 104. In addition the RAM 106 may be operable to store images and blocks of pixels as processing of images of the video sequences is carried out on the video sequences (transform, quantization, storage of reference images etc.);
a screen 108 for displaying data, in particular video and/or serving as a graphical interface with the user, who may thus interact with the programs according to embodiments of the invention, using a keyboard 110 or any other means e.g. a mouse (not shown) or pointing device (not shown);
a hard disk 112 or a storage memory, such as a memory of compact flash type, able to contain the programs of embodiments of the invention as well as data used or produced on implementation of the invention;
an optional disc drive 114, or another reader for a removable data carrier, adapted to receive a disc 116 and to read/write thereon data processed, or to be processed, in accordance with embodiments of the invention and;
a communication interface 118 connected to a telecommunications network 34
connection to a digital camera 101; It will be appreciated that in some embodiments of the invention the digital camera and the microphone may be integrated into the device 100 itself.

The communication bus 102 permits communication and interoperability between the different elements included in the device 100 or connected to it. The representation of the communication bus 102 given here is not limiting. In particular, the CPU 103 may communicate instructions to any element of the device 100 directly or by means of another element of the device 100.

The disc 116 can be replaced by any information carrier such as a compact disc (CD-ROM), either writable or rewritable, a ZIP disc, a memory card or a USB key. Generally, an information storage means, which can be read by a micro-computer or microprocessor, which may optionally be integrated in the device 100 for processing a video sequence, is adapted to store one or more programs whose execution permits the implementation of the method according to the invention.

The executable code enabling a coding device to implement one or more embodiments of the invention may be stored in ROM 104, on the hard disc 112 or on a removable digital medium such as a disc 116.

The CPU 103 controls and directs the execution of the instructions or portions of software code of the program or programs of embodiments of the invention, the instructions or portions of software code being stored in one of the aforementioned storage means. On powering up of the device 100, the program or programs stored in non-volatile memory, e.g. hard disc 112 or ROM 104, are transferred into the RAM 106, which then contains the executable code of the program or programs of embodiments of the invention, as well as registers for storing the variables and parameters necessary for implementation of embodiments of the invention.

It may be noted that the device implementing one or more embodiments of the invention, or incorporating it, may be implemented in the form of a programmed apparatus. For example, such a device may then contain the code of the computer program or programs in a fixed form in an application specific integrated circuit (ASIC).

The exemplary device 100 described here and, particularly, the CPU 103, may implement all or part of the processing operations as described in what follows.

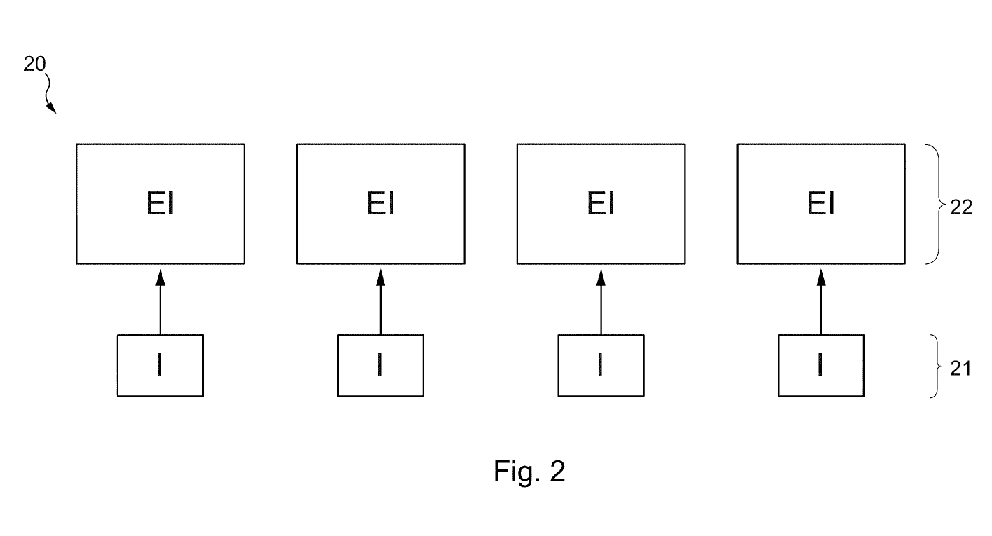

FIG. 2 schematically illustrates an example of the structure of a scalable video stream 20 in which each of the images are encoded in an INTRA mode. As shown, an all-INTRA coding structure includes a series of images which are encoded independently from each other. The base layer 21 of the scalable video stream 20 is illustrated at the bottom of the figure. In this base layer, each image is INTRA coded and is usually referred to as an “I” image. INTRA coding involves predicting a macroblock or block of pixels from its directly neighbouring macroblocks or blocks within a single image or frame.

A spatial enhancement layer 22 is encoded on top of the base layer 21 as illustrated at the top of FIG. 2. This spatial enhancement layer 22 introduces some spatial refinement information over the base layer. In other words, the decoding of this spatial layer leads to a decoded video sequence that has a higher spatial resolution than the base layer. The higher spatial resolution adds to the quality of the reproduced images.

As illustrated in FIG. 2, each enhancement image, denoted an ‘El’ image, is intra coded. An enhancement INTRA image is encoded independently from any other enhancement image. It is coded in a predictive way, by predicting it only from the temporally coincident image in the base layer.

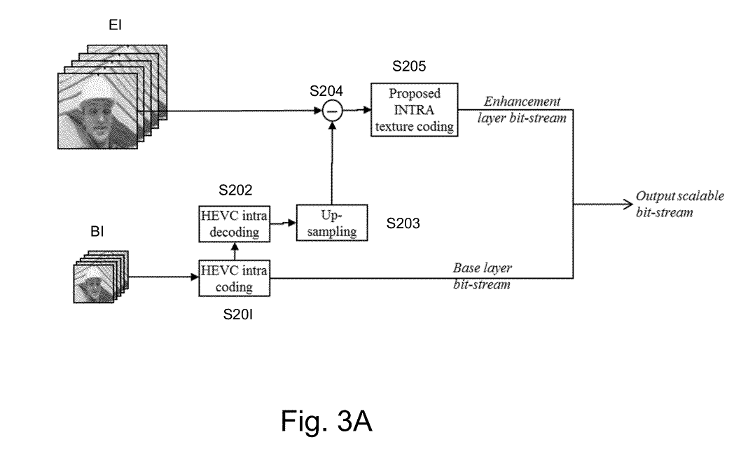

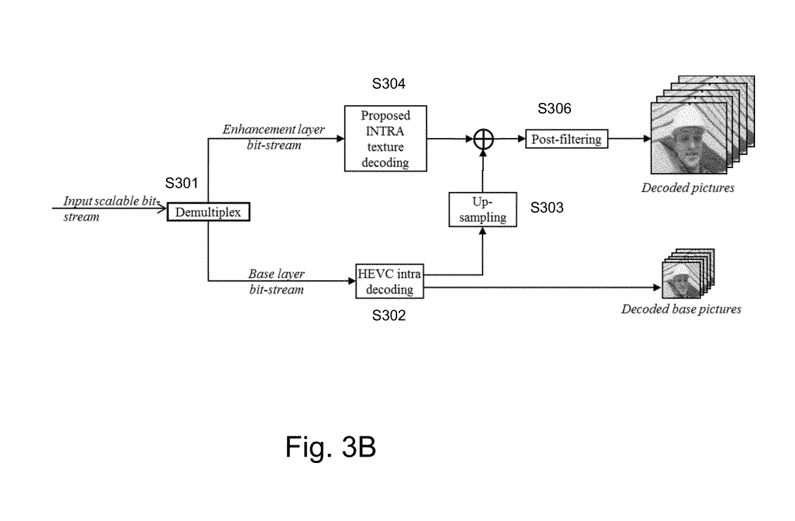

The coding process of the images is illustrated in FIG. 3A. In step S201 base layer images are intra coded providing a base layer bitstream. In step S202 an intra-coded base layer image is decoded to provide a reconstructed base image which is up-sampled in step S203 towards the spatial resolution of the enhancement layer, in the case of spatial scalability. DCT-IF interpolation filters are used in this up-sampling step. Then the texture residual picture between the original enhancement image to be coded and the up-sampled base image is computed in step S204, and then is encoded according to an INTRA texture coding process in step S205. It may be noted that INTRA enhancement picture coding process according to embodiments of the invention is low-complexity, i.e. it involves no coding mode decision step as in standard video coding systems. Instead, only one coding mode is involved in enhancement INTRA picture, which corresponds to a so-called inter-layer intra prediction process.

An example of an overall enhancement INTRA picture decoding process is schematically illustrated in FIG. 3B. The input bit-stream to the decoder comprises the HEVC-coded base layer and the enhancement layer comprising coded enhancement INTRA pictures. The input bitstream is demultiplexed in step S301 into a base-layer bitstream and an enhancement layer bitstream. The base layer is decoded in step S302 providing a reconstructed base picture. The reconstructed base picture is up-sampled in step S303 to the resolution of the enhancement layer. The enhancement layer is decoded as follows. An inter-layer residual texture decoding process is employed in step S304, providing a reconstructed inter-layer residual picture. The decoded residual picture is then added to the reconstructed base picture in step S305. The so-reconstructed enhancement picture undergoes a HEVC post-filtering processes in step S306, i.e. de-blocking filter, sample adaptive offset (SAO) and Adaptive Loop Filter (ALF).

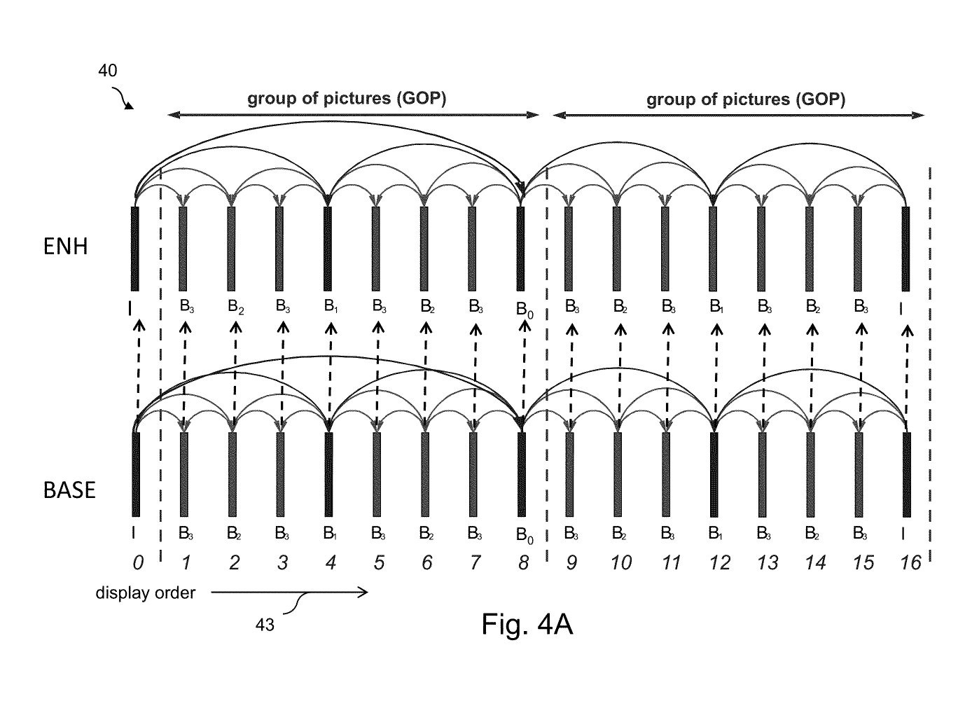

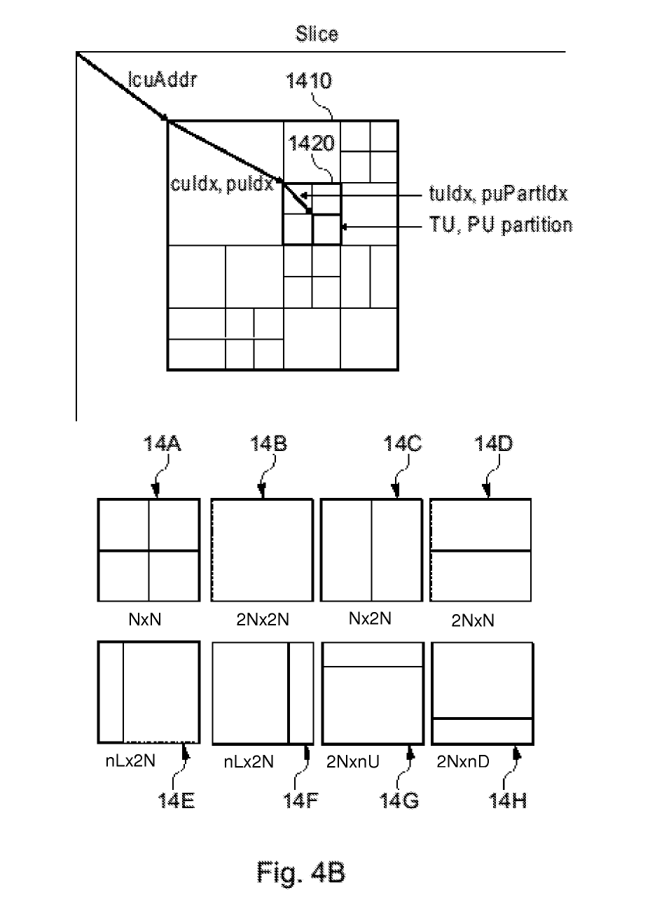

FIG. 4A schematically illustrates a random access temporal coding structure employed in one or more embodiments of the invention. The input sequence is broken down into groups of images (pictures) GOP in a base layer and an enhancement layer. A random access property signifies that several access points are enabled in the compressed video stream, i.e. the decoder can start decoding the sequence at any image in the sequence which is not necessarily the first image in the sequence. This takes the form of periodic INTRA image coding in the stream as illustrated by FIG. 4A.

In addition to INTRA images, the random access coding structure enables INTER prediction, both forward and backward (in relation to the display order as represented by arrow 43) predictions can be effected. This is achieved by the use of B images, as illustrated. The random access configuration also provides temporal scalability features, which takes the form of the hierarchical organization of B images, B₀ to B₃ as illustrated, as shown in the figure.

It can be seen that the temporal codec structure used in the enhancement layer is identical to that of the base layer corresponding to the Random Access HEVC testing conditions so far employed.

In the proposed scalable HEVC codec, according to at least one embodiment of the invention, INTRA enhancement images are coded in the same way as in All-INTRA configuration previously described. In particular, this involves the base picture up-sampling and the texture coding/decoding process as described with reference to FIGS. 2, 3A and 3B.

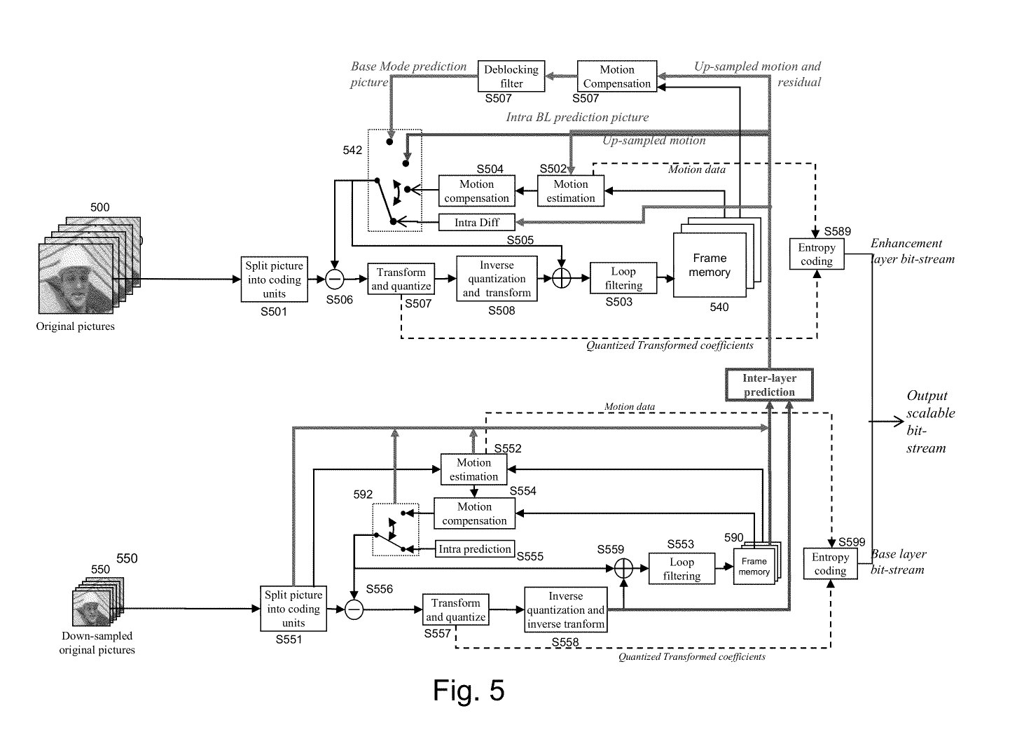

FIG. 5 is a schematic block diagram of a scalable encoding method according to at least one embodiment of the invention and conforming to a HEVC or a H264/AVC video compression system. The scalable encoding method includes 2 subparts or stages, for respectively coding the HEVC base layer and the HEVC enhancement layer on top of the base layer. It will be appreciated that the encoding method may include any number of stages depending on the number of enhancement layers in the video data. In each stage, closed-loop motion estimation and compensation are performed.

The input to the scalable encoding method includes a sequence of the original images to be encoded 500 and a sequence of the original images down-sampled to the base layer resolution 550.

The first stage aims at encoding the HEVC compliant base layer of the scalable video stream. The second stage then performs encoding of an enhancement layer on top of the base layer. This enhancement layer brings a refinement of the spatial resolution (in the case of spatial scalability) or of the quality (SNR quality) compared to the base layer.

With reference to FIG. 5 the coder implementing the scalable encoding method proceeds as follows. A first image or frame to be encoded (compressed) is divided into blocks of pixels, called CTB (coded Tree Block) in the HEVC standard. These CTBs are then divided into coding units of variable sizes which are the elementary coding elements in HEVC. Coding units are then partitioned into one or several prediction units for prediction as will be described in detail later.

FIG. 4B depicts coding units and prediction units concepts specified in the HEVC standard. A coding unit of an HEVC image corresponds to a square block of that image, and can have a size in a pixel range from 8×8 to 64×64. A coding unit which has the greatest size authorized for the considered image is also referred to as a Largest Coding Unit (LCU) or CTB (coded tree block) 1410. As already mentioned above, for each coding unit of the enhancement image, the encoder decides how to partition it into one or several prediction units (PU) 1420. Each prediction unit can have a square or rectangular shape and is given a prediction mode (INTRA or INTER) and associated prediction information. With respect to INTRA prediction, the associated prediction parameters include the angular direction used in the spatial prediction of the considered prediction unit, associated with corresponding spatial residual data. In case of INTER prediction, the prediction information comprises the reference image indices and the motion vector(s) used to predict the considered prediction unit, and the associated temporal residual texture data. Illustrations 14A to 14H show some of the possible arrangements of partitioning which are available.

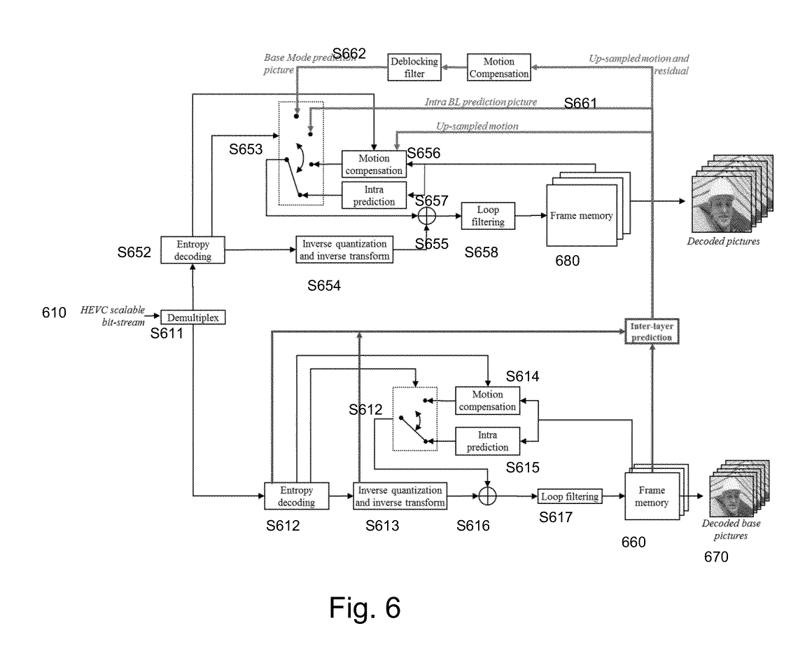

For the purpose of simplification in the example of the processes of FIGS. 5 and 6 it may be considered that coding units and prediction units coincide. In the first stage a down-sampled first image is thus split in step S551 into coding units. In step S501 of the second stage the original image to be encoded (compressed) is split into coding units of pixels corresponding to processing blocks.

In the first stage in motion estimation step S552 the coding units of the down sampled image undergo a motion estimation operation involving a search among reference images stored in a memory buffer 590 for reference images that would provide a good prediction of the current coding unit. The reference image is loop filtered in step S553. Motion estimation step S552 includes one or more estimation steps providing one or more reference image indexes which identify the suitable reference images containing reference areas, as well as the corresponding motion vectors which identify the reference areas in the reference images. A motion compensation step S554 then applies the estimated motion vectors to the identified reference areas and copies the identified reference areas into a temporal prediction image. An Intra prediction step S555 determines the spatial prediction mode that would provide the best performance to predict the current coding unit and encode it in INTRA mode, in order to provide a prediction area.

A coding mode selection mechanism 592 selects the coding mode, from among the spatial and temporal predictions, of steps S555 and S554 respectively, providing the best rate distortion trade-off in the coding of the current coding unit. The difference between the current coding unit from step S551 and the selected prediction area (not shown) is then calculated in step S556 providing a (temporal or spatial) residual to compress. The residual coding unit then undergoes a transform (DCT) and a quantization in step S557. Entropy coding of the so-quantized coefficients QTC (and associated motion data MD) is performed in step S599. The compressed texture data associated with the coded current coding unit is then sent for output.

Following the transform and quantisation step S557 current coding unit is reconstructed in step S558 by scaling (inverse quantization) and inverse transformation followed by a summing in step S559 between the inverse transformed residual and the prediction area of the current coding unit, selected by selection module 592. The reconstructed current image is stored in a memory buffer 590 (the DPB, Decoded Image Buffer) so that it is available for use as a reference image to predict any subsequent images to be encoded.

Finally, the entropy coding step S599 is provided with the coding mode and, in case of an inter coding unit, the motion data, as well as the quantized DCT coefficients previously calculated. This entropy coder encodes each of these data into their binary form and encapsulates the so-encoded coding unit into a container called NAL unit (Network Abstract Layer). A NAL unit contains all encoded coding units from a given slice. A coded HEVC bit-stream includes a series of NAL units.

As shown in FIG. 5, the coding scheme of the enhancement layer is similar to that of the base layer, except that for each coding unit (processing block) of a current enhancement image being encoded (compressed), additional prediction modes may be selected by the coding mode selection module 542 according, for example, to a rate distortion trade off criterion. The additional prediction modes correspond to inter-layer prediction modes.

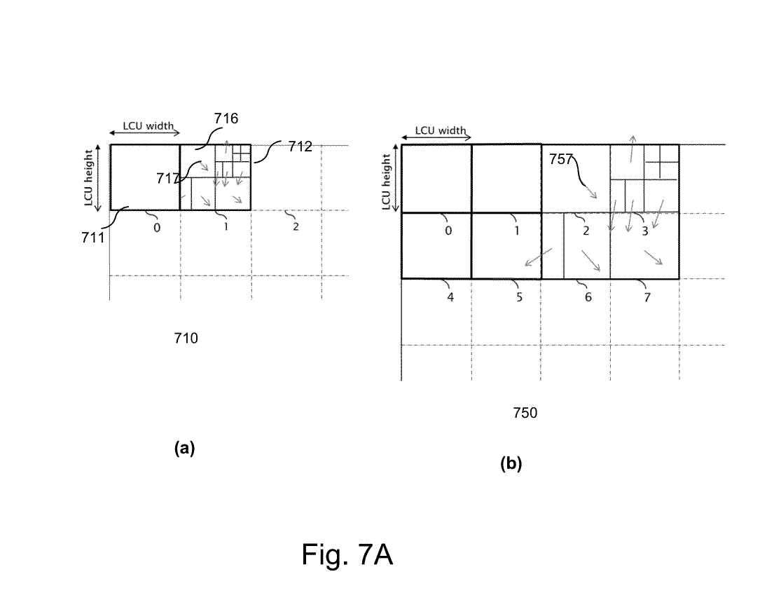

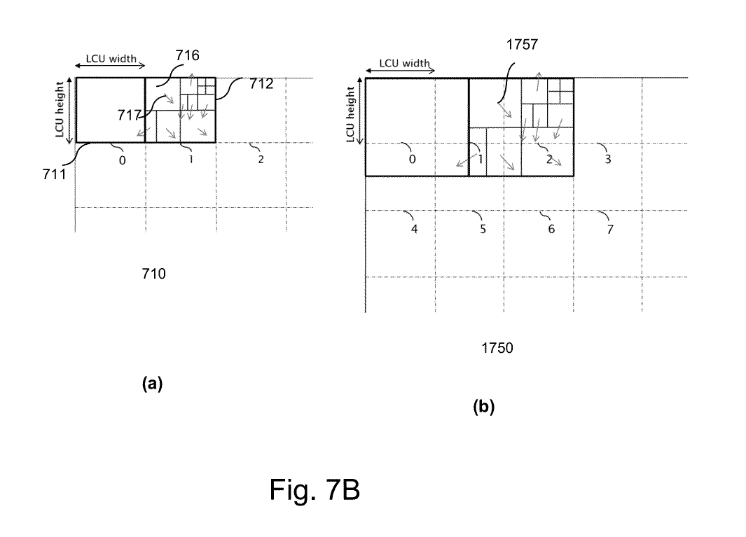

The goal of inter-layer prediction is to exploit the redundancy that exists between a coded base layer and the enhancement images to be encoded or decoded, in order to obtain as much compression efficiency as possible in the enhancement layer. Inter-layer prediction involves re-using the coded data from a layer of the video data lower in quality than the current refinement layer (in this case the base layer), as prediction data for the current coding unit of the current enhancement image. The lower layer used is referred to as the reference layer or base layer for the inter-layer prediction of the current enhancement layer. In the case where the reference layer contains an image that temporally coincides with the current enhancement image, then it is referred to as the base image of the current enhancement image. A co-located coding unit of the base layer (corresponding spatially to the current enhancement coding unit) that has been coded in the reference layer can be used as a reference to predict the current enhancement coding unit as will be described in more detail with reference to FIGS. 7-11. Prediction data from the base layer that can be used in the predictive coding of an enhancement coding unit includes the CU prediction information, the motion data (if present) and the texture data (temporal residual or reconstructed base CU). In the case of a spatial enhancement layer some up-sampling operations of the texture and prediction data are performed. The goal of inter-layer prediction is thus to exploit the redundancy that exists between a coded base layer and the enhancement pictures to be encoded or decoded, in order to obtain as much compression efficiency as possible in the enhancement layer.

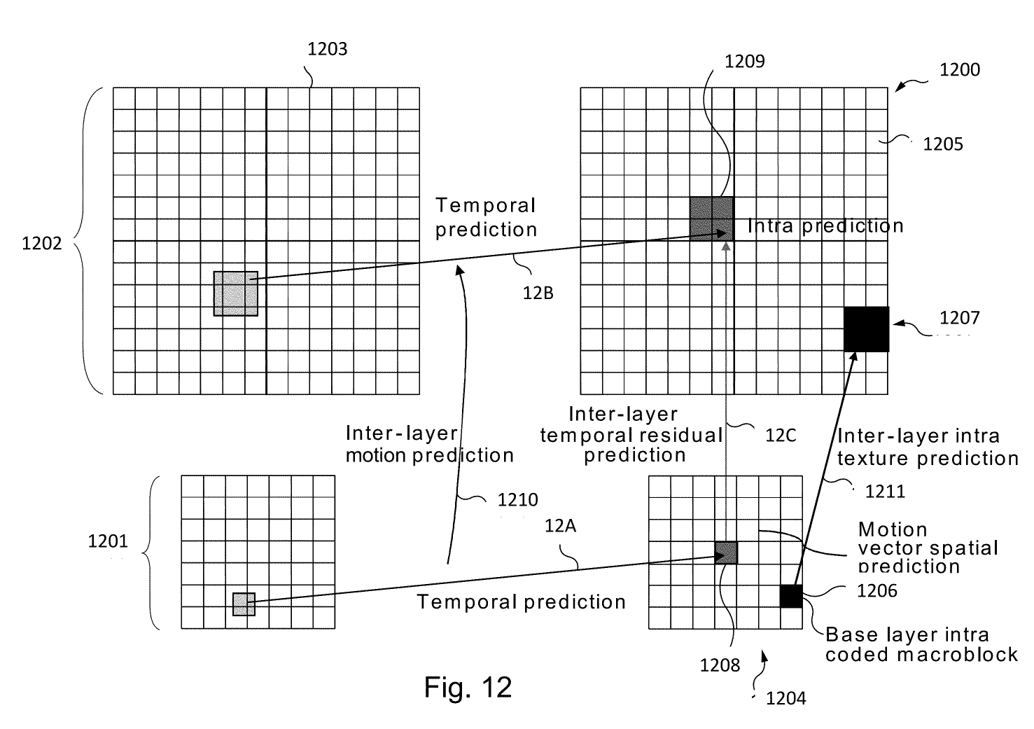

Inter-layer prediction tools that are used in embodiments of the invention for the coding or decoding of enhancement images are as follows:
Intra BL prediction mode involves predicting an enhancement coding unit from its co-located area in the reconstructed base image, up-sampled in the case of spatial enhancement. The Intra BL prediction mode is usable regardless of the way the co-located base coding unit of a given enhancement coding unit was coded by virtue of the multiple loop decoding approach employed. The Intra BL prediction coding mode is signaled at the prediction unit (PU) level as a particular inter-layer prediction mode.
Base Mode prediction involves predicting a coding unit from its co-located area in a so-called Base Mode prediction image. The Base Mode prediction image is constructed at both the encoder and decoder ends using prediction information derived from the base layer. The construction of this base mode prediction image is explained in detail below, with reference to FIG. 12. Briefly, it is constructed by predicting a current enhancement image by means of the up-sampled prediction information and temporal residual data that has previously been extracted from the base layer and re-sampled to the enhancement spatial resolution.

In the case of SNR scalability, the derived prediction information corresponds to the Coding Unit structure of the base picture, taken as is, before the motion information compression step performed in the base layer.
In the case of spatial scalability, the prediction information of the base layer firstly undergoes a so-called prediction information up-sampling process.
Once the derived prediction information is obtained, a Base Mode prediction picture is computed, by means of temporal prediction of derived INTER CUs and Intra BL prediction of derived INTRA CUs
Inter layer prediction of motion information attempts to exploit the correlation between the motion vectors coded in the base picture and the motion contained in the topmost layer.
Generalized Residual Inter-Layer Prediction (GRILP) involves predicting the temporal residual of an INTER coding unit, from a temporal residual computed between reconstructed base images. This prediction method, employed in case of multi-loop decoding, comprises constructing a “virtual” residual in the base layer by applying the motion information obtained in the enhancement layer to the coding unit of the base layer co-located to the coding unit to predict in the enhancement layer to identify a predictor co-located to the predictor of the enhancement layer.

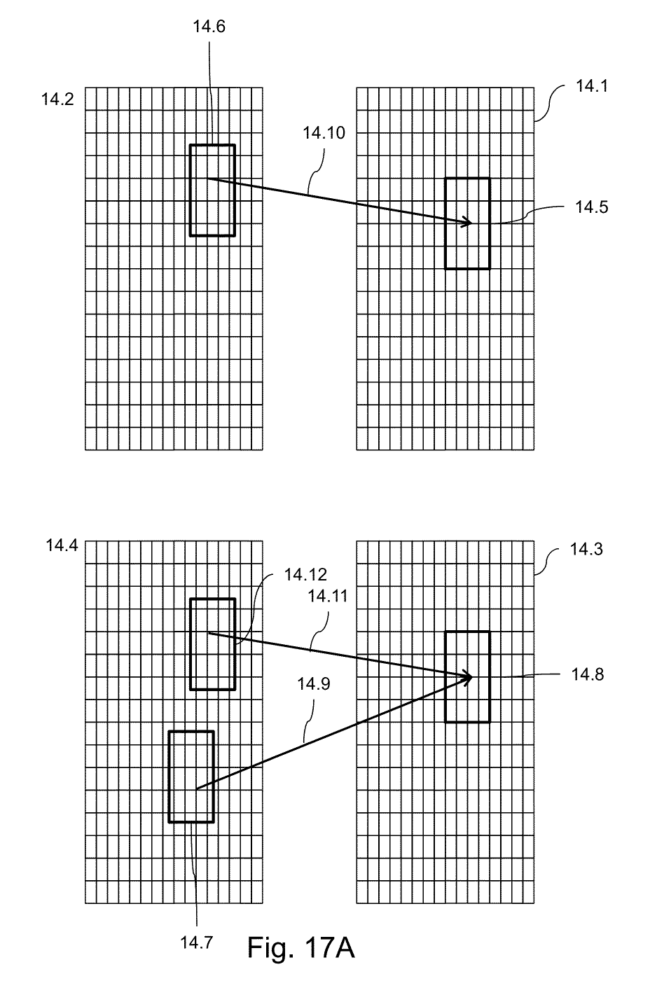

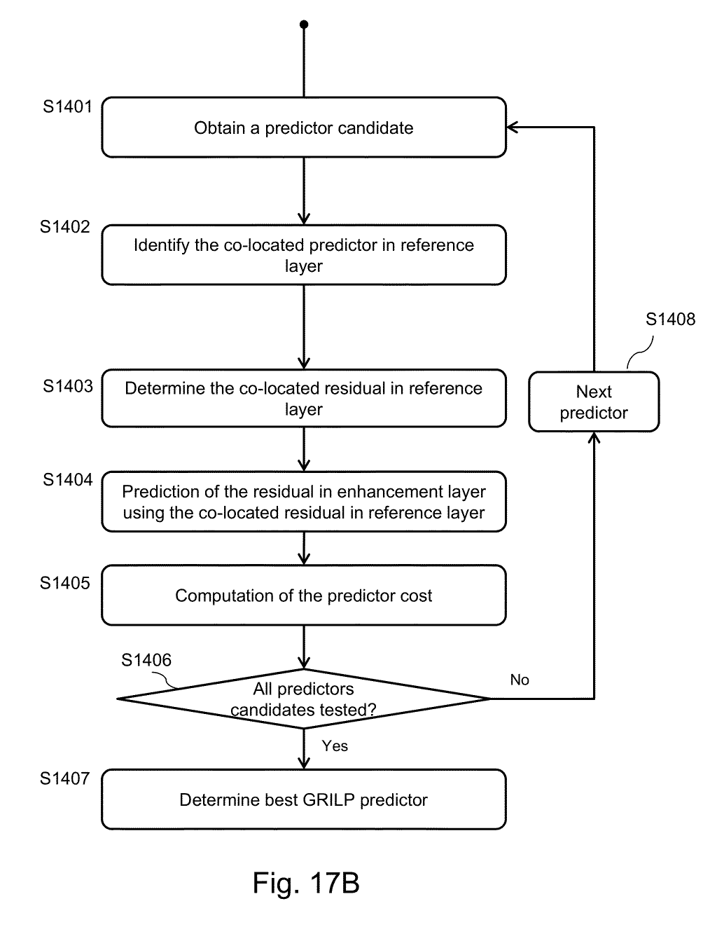

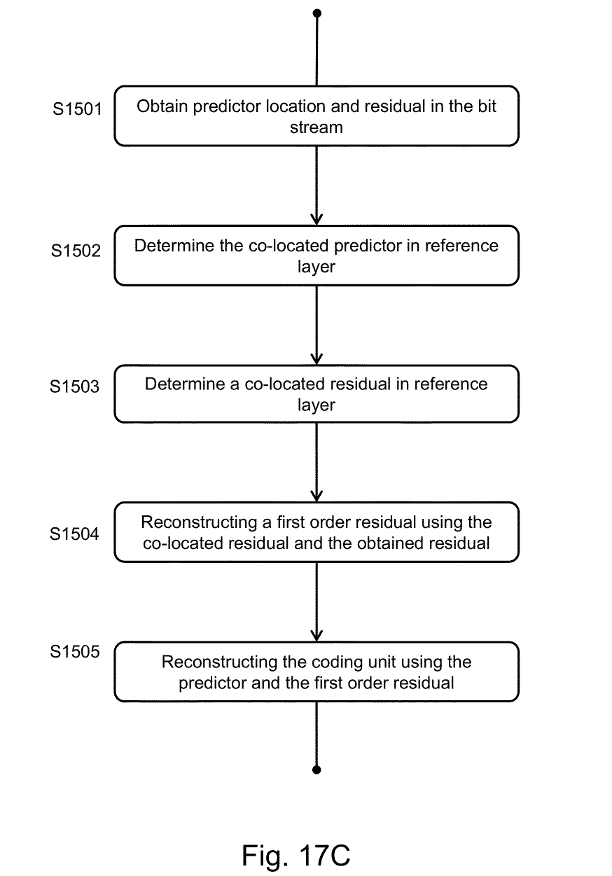

A GRILP mode according to an embodiment of the invention will now be described in relation to FIGS. 17A and 1B. The image to be encoded, or decoded, is the image representation 14.1 in the enhancement layer in FIG. 17A. This image is composed of original pixels. Image representation 14.2 in the enhancement layer is available in its reconstructed version. The base layer, it depends on the scalable decoder architecture considered. If the encoding mode is single loop, meaning that the base layer reconstruction is not brought to completion, the image representation 14.4 is composed of inter blocks decoded until their residual is obtained but to which motion compensation is not applied and intra blocks which may be integrally decoded as in SVC or partially decoded until their intra prediction residual is obtained as well as a prediction direction. It may be noted that in FIG. 17A, both layers are represented at the same resolution as in SNR scalability. In Spatial scalability, two different layers will have different resolutions which require an up-sampling of the residual and motion information before performing the prediction of the residual.

In the case where the encoding mode is multi loop, a complete reconstruction of the base layer is conducted. In this case, image representation 14.4 of the previous image and image representation 14.3 of the current image both in the base layer are available in their reconstructed version.

As seen with reference to step 542 of FIG. 5, a selection is made between all available modes in the enhancement layer to determine a mode optimizing a rate-distortion trade off. The GRILP mode is one of the modes which may be selected for encoding a block of an enhancement layer.

In one particular embodiment a first version of the GRILP adapted to temporal prediction in the enhancement layer is described. This embodiment starts with the determination of the best temporal GRILP predictor in a set comprising several potential temporal GRILP predictors obtained using a block matching algorithm.

In a first step S1401, a predictor candidate contained in the search area of the motion estimation algorithm is obtained for block 14.5. This predictor candidate represents an area of pixels 14.6 in the reconstructed reference image 14.2 in the enhancement layer pointed to by a motion vector 14.10. A difference between block 14.5 and block 14.6 is then computed to obtain a first order residual in the enhancement layer. For the considered reference area 14.6 in the enhancement layer, the corresponding co-located area 14.12 in the reconstructed reference layer image 14.4 in the base layer is identified in step S1402 In step S1403 a difference is computed between block 14.8 and block 14.12 to obtain a first order residual for the base layer. In step S1404, a prediction of the first order residual of the enhancement layer by the first order residual of the base layer is performed. This last prediction allows a second order residual to be obtained. It may be noted that the first order residual of the base layer does not correspond to the residual used in the predictive encoding of the base layer which is based on the predictor 14.7. This first order residual is a kind of virtual residual obtained by reporting in the reference layer the motion vector obtained by the motion estimation conducted in the enhancement layer. Accordingly, by being obtained from co-located pixels, it is expected to be a good predictor for the residual obtained in the enhancement layer. To emphasize this distinction and the fact that it is obtained from co-located pixels, it will be called the co-located residual in the following.

In step 1405, the rate distortion cost of the GRILP mode under consideration is evaluated. This evaluation is based on a cost function depending on several factors. An example of such a cost function is:

C=D++λ(Rₛ+Rₘᵥ+Rᵣ);

where C is the obtained cost, D is the distortion between the original coding unit to be encoded and its reconstructed version after encoding and decoding. Rₛ+Rₘᵥ+Rᵣ represents the bitrate of the encoding, where Rₛ is the component for the size of the syntax element representing the coding mode, Rₘᵥ is the component for the size of the encoding of the motion information, and Rᵣ is the component for the size of the second order residual. λ is the usual Lagrange parameter.

In step 1406 a test is performed to determine if all predictor candidates contained in the search area have been tested. If some predictor candidates remain, the process loops back to step 1401 with a new predictor candidate. Otherwise, all costs are compared during step 1407 and the predictor candidate minimizing the rate distortion cost is selected.

The cost of the best GRILP predictor will then be compared to the costs of other predictors available for blocks in an enhancement layer to select the best prediction mode. If the GRILP mode is finally selected, a mode identifier, the motion information and the encoded residual are inserted in the bit stream.

The decoding of the GRILP mode is illustrated in FIG. 17C, The bit stream comprises the means to locate the predictor and the second order residual. In a first step S1501, the location of the predictor used for the prediction of the coding unit and the associated residual are obtained from the bit stream. This residual corresponds to the second order residual obtained at encoding. In a step S1502, similarly to encoding, the co-located predictor is determined. It is the location in the base layer of the pixels corresponding to the predictor obtained from the bit stream. In a step 1503, the co-located residual is determined. This determination may vary according to the particular embodiment similarly to what is done in encoding. In the context of multi loop and inter encoding it is defined by the difference between the co-located coding unit and the co-located predictor in the reference layer. In a step S1504, the first order residual is reconstructed by adding the residual obtained from the bit stream which corresponds to the second order residual and the co-located residual. Once the first order residual has been reconstructed, it is used with the predictor which location has been obtained from the bit stream to reconstruct the coding unit in a step S1505.

In an alternative embodiment allowing a reduction of the complexity of the determination of the best GRILP predictor, it is possible to perform the motion estimation in the enhancement without considering the prediction of the first order residual. The motion estimation becomes classical and provides a best temporal predictor in the enhancement layer. In FIG. 17B, this embodiment consists in replacing step S1401 by a complete motion estimation step determining the best temporal predictor among the predictor candidates in the enhancement layer and by removing steps S1406, S1407 and S1408. All other steps remain identical and the cost of the GRILP mode is then compared to the costs of other modes.

FIG. 6 is a block diagram of a scalable decoding method for application on a scalable bit-stream comprising two scalability layers, e.g. comprising a base layer and an enhancement layer. The decoding process may thus be considered as corresponding to reciprocal processing of the scalable coding process of FIG. 5. The scalable bitstream being decoded 610, as shown in FIG. 6 is made of one base layer and one spatial enhancement layer on top of the base layer, which are demultiplexed in step S611 into their respective layers. It will be appreciated that the process may be applied to a bitstream with any number of enhancement layers.

The first stage of FIG. 6 concerns the base layer decoding process. The decoding process starts in step S612 by entropy decoding each coding unit of each coded image in the base layer. The entropy decoding process S612 provides the coding mode, the motion data (reference images indexes, motion vectors of INTER coded coding units) and residual data. This residual data includes quantized and transformed DCT coefficients. Next, these quantized DCT coefficients undergo inverse quantization (scaling) and inverse transform operations in step S613. The decoded residual is then added in step S616 to a temporal prediction area from motion compensation S614 or an Intra prediction area from Intra prediction step S616 to reconstruct the coding unit. Loop filtering is effected in step S617. The so-reconstructed residual data is then stored in the frame buffer 660. The decoded motion and temporal residual for INTER coding units may also be stored in the frame buffer. The stored frames contain the data that can be used as reference data to predict an upper scalability layer. Decoded base images 670 are obtained.

The second stage of FIG. 6 performs the decoding of a spatial enhancement layer EN on top of the base layer decoded by the first stage. This spatial enhancement layer decoding includes entropy decoding of the enhancement layer in step S652, which provides the coding modes, motion information as well as the transformed and quantized residual information of coding units of the enhancement layer.

A subsequent step of the decoding process involves predicting coding units in the enhancement image. The choice S653 between different types of coding unit prediction (INTRA, INTER, Intra BL or Base mode) depends on the prediction mode obtained from the entropy decoding step S652.

The prediction of each enhancement coding unit thus depends on the coding mode signalled in the bitstream. According to the CU coding mode the coding units are processed as follows
In the case of an inter-layer predicted INTRA coding unit, the enhancement coding unit is reconstructed through inverse quantization and inverse transform in step S654 to obtain residual data and adding in step S655 the resulting residual data to Intra prediction data from step S657 to obtain the fully reconstructed coding unit. Loop filtering is then effected in step S658.
In the case of an INTER coding unit, the reconstruction involves the motion compensated temporal prediction S656, the residual data decoding in step S654 and then the addition of the decoded residual information to the temporal predictor in step S655. In such an INTER coding unit decoding process, inter-layer prediction can be used in two ways. First, the temporal residual data associated with the considered enhancement layer coding unit may be predicted from the temporal residual of the co-sited coding unit in the base layer by means of generalized residual inter-layer prediction. Second, the motion vectors of prediction units of a considered enhancement layer coding unit may be decoded in a predictive way, as a refinement of the motion vector of the co-located coding unit in the base layer.
In the case of an Intra-BL coding mode, the result of the entropy decoding of step S652 undergoes inverse quantization and inverse transform in step S654, and then is added in step S655 to the co-located coding unit of current coding unit in base image, in its decoded, post-filtered and up-sampled (in case of spatial scalability) version.
In the case of Base-Mode prediction the result of the entropy decoding of step S652 undergoes inverse quantization and inverse transform in step S654, and then is added to the co-located area of current CU in the Base Mode prediction picture in step S655.

As mentioned previously, it may be noted that the Intra BL prediction coding mode is allowed for every CU in the enhancement image, regardless of the coding mode that was employed in the co-sited Coding Unit(s) of a considered enhancement CU. Therefore, the proposed approach consists in a multiple loop decoding system, i.e. the motion compensated temporal prediction loop is involved in each scalability layer on the decoder side.

A method of deriving prediction information, in a base-mode prediction mode, for encoding or decoding at least part of an image of an enhancement layer of video data, in accordance with an embodiment of the invention will now be described. Embodiments of the present invention addresses, in particular, HEVC prediction information up-sampling in the case of spatial scalability with scaling ratio 1.5 between two successive scalability layers.

FIGS. 7A and 7B schematically illustrate prediction information up-sampling processes, executed both by the encoder and the decoder in embodiments of the invention. The organization of the coded base image, in terms of LCU, coding units (CUs) and prediction units (PUs) is schematically illustrated in FIG. 7A(a) or FIG. 7B(a). FIG. 7A(b) and FIG. 7B(b) schematically illustrate the enhancement image organization in terms of LCUs, CUs and PUs, resulting from respective prediction information up-sampling processes applied to the base image prediction information. By prediction information, in this example is meant a coded image structure in terms of LCUs, CUs and PUs.

FIG. 7A illustrates prediction information up-sampling according to an embodiment of the invention in the case of dyadic scalability while FIG. 7B illustrates prediction information up-sampling according to an embodiment of the invention in the case of non-integer upscaling ratio.

FIG. 7A(a) and FIG. 7B(a) illustrates a part 710 of a base layer image of the base layer. In particular, the Coding Unit representation that has been used to encode the base image is illustrated, for the two first LCUs (Largest Coding Unit) 711 and 712 of the base image. The LCUs have a height and width, as illustrated, and an identification number, here shown running from zero to two. The individual prediction units exist in a scaling relationship known as a quad-tree. The Coding Unit quad-tree representation of the second LCU 712 is illustrated, as well as prediction unit (PU) partitions e.g. partition 716. Moreover, the motion vector associated with each prediction unit, e.g. vector 717 associated with prediction unit 716, is shown.

In FIG. 7A(b), the result 750 of the prediction information up-sampling process applied to base layer 710 is illustrated in the case of dyadic scalability while FIG. 7B(b) the result 750 of the prediction information up-sampling process applied to base layer 710 is illustrated in the case of a non-integer scaling factor of 1.5. In both cases the LCU size in the enhancement layer is identical to the LCU size in the base layer.

With reference to FIG. 7A(b) the LCU size is the same in the enhancement image 750 as in the base image 710. As can be seen, the up-sampled of base layer LCU 1 results in the enhancement layers LCUs 2, 3, 6 and 7. Moreover, the coding unit quad-tree of the base layer has been re-sampled as a function of the scaling ratio that exists between the enhancement image and the base image. The prediction unit partitioning is of the same type (i.e. PUs have the same shape) in the enhancement layer and in the base layer. Finally, motion vector coordinates have been re-scaled as a function of the spatial ratio between the two layers.

In other words, three main steps are involved in the prediction information up-sampling process.
the Coding Unit quad-tree representation is first up-sampled. To do so, the depth parameter of the base coding unit is decreased by 1 in the enhancement layer.
the Coding Unit partitioning mode is kept the same in the enhancement layer, compared to the base layer. This leads to Prediction Units that have an up-scaled size in the enhancement layer, and have the same shape as their corresponding PU in the base layer.
the motion vector is re-sampled to the enhancement layer resolution, simply by multiplying their x and y coordinates by the appropriate scaling ratio.

With reference to FIG. 7B(b), it can be seen that in the case of spatial scalability of 1.5, the block (LCU) to block correspondence between the base layer and the enhancement layer differs from the dyadic case. The prediction information that corresponds to one LCU in the base image spatially overlaps several LCUs in the enhancement image. For example, the up-sampled version of base LCU 712 results in at least parts of the enhancement LCUs 1, 2, 5 and 6 It may be noted that the coding unit quad-tree structure of coding unit 712 has been re-sampled in 750 as a function of the scaling ratio of 1.5, that exists between the enhancement image and the base image. The prediction unit partitioning is of the same type (i.e. the corresponding prediction units have the same shape) in the enhancement layer and in the base layer. Finally, motion vector coordinates e.g. 1757 have been re-scaled as a function of the spatial ratio between the two layers.

As a result of the prediction information up-sampling process, prediction information is available on the encoder and on the decoder side, and can be used in various inter-layer prediction mechanisms in the enhancement layer.

In the scalable encoder and decoder architectures according to embodiments of the invention, this up-scaled prediction information is used in two ways.
in the construction of a “Base Mode” prediction image of a considered enhancement image,
for the inter-layer prediction of motion vectors in the coding of the enhancement image.

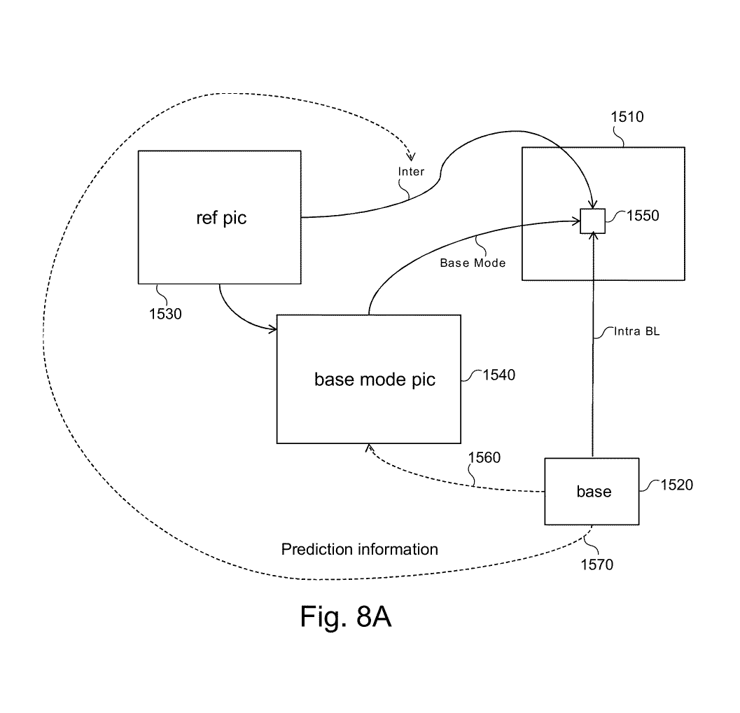

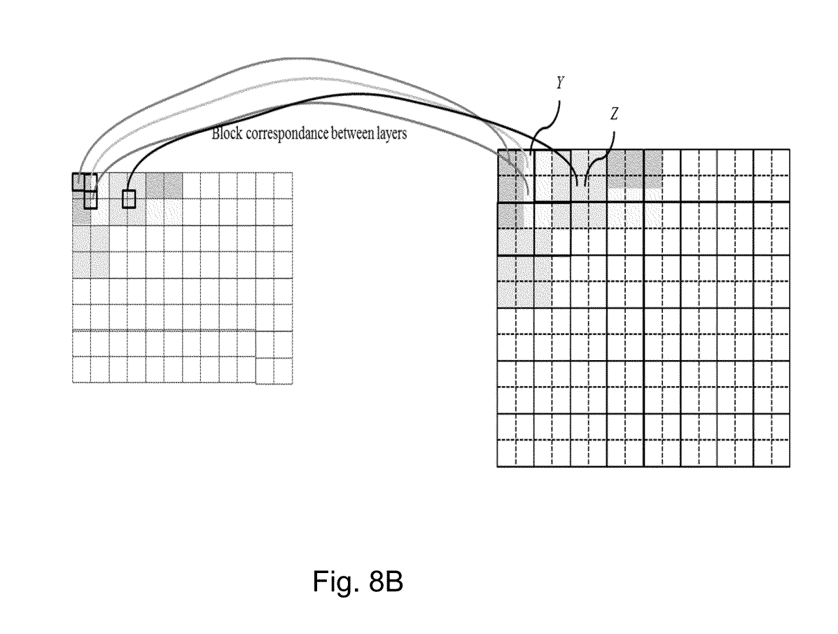

FIG. 8A schematically illustrates prediction modes that can be used in the proposed scalable codec architecture, according to an embodiment of the invention, for prediction of a current enhancement image. Schematic 1510 corresponds to the current enhancement image to be predicted. The base image 1520 corresponds to the base layer decoded image that temporally coincides with current enhancement image. Schematic 1530 corresponds to an example reference image in the enhancement layer used for the temporal prediction of the current image 1510. Schematic 1540 corresponds to the Base Mode prediction image as described with reference to FIG. 12.

As illustrated by FIG. 8A, the prediction of current enhancement image 1510 comprises determining, for each block 1550 in current enhancement image 1510, the best available prediction mode for that block 1550, considering prediction modes including temporal prediction, Intra BL prediction and Base Mode prediction.

FIG. 8A also illustrates how the prediction information contained in the base layer is extracted, and then used in two different ways.

First, the prediction information of the base layer is used to construct 1560 the “Base Mode” prediction image 1540. This construction is discussed below with reference to FIG. 12.

Second, the base layer prediction information is used in the predictive coding 1570 of motion vectors in the enhancement layer. Therefore, the INTER prediction mode illustrated on FIG. 8A makes use of the prediction information contained in the base image 1520. This allows inter-layer prediction of the motion vectors of the enhancement layer, hence increases the coding efficiency of the scalable video coding system.

The overall prediction up-sampling processes of FIGS. 7A and 7B involve up-sampling first the coding unit structure, and then up-sampling the prediction unit partitions. The goal of inter-layer prediction information derivation is to keep as much accuracy as possible in the up-scaled prediction unit and motion information, in order to generate as accurate a Base Mode prediction image as possible.

In the case of spatial scalability having a scaling ratio of 1.5 as in FIG. 7B, the block-to-block correspondence between the base image and the enhancement picture is more complex than would be in the dyadic case of FIG. 7A.

A method in accordance with an embodiment of the invention for deriving prediction information in the case of a scaling ratio of 1.5 is as follows:

Each Largest Coding Unit (LCU) in the enhancement image to be encoded or decoded is split into coding units (CU)s having a minimum size (e.g. 4×4). Each CU obtained in this way is then considered as a prediction unit having a prediction unit type 2N×2N.

The prediction information of each obtained 4×4 prediction unit is computed as a function of prediction information associated with the co-located area in the base layer as will be described in more detail. The prediction information derived from the base layer includes the following:
Prediction mode,
Merge information,
Intra prediction direction (if relevant),
Inter direction,
Cbf (Coded block flag)values,
Partitioning information,
CU size,
Motion vector prediction information,
Motion vector values (It may be noted that the motion field is inherited prior to the motion compression that takes place in the base layer).

Derived motion vector coordinates are computed as follows:

$$\begin{matrix}{mv}_{x} = {mvbase}_{x} \times \frac{PicWidthEnh}{PicWidthBase} & ( 1 ) \\ {mv}_{y} = {mvbase}_{y} \times \frac{PicHeightEnh}{PicHeightBase} & ( 2 )\end{matrix}$$

where:
(mvₓ,mv_{y}) represents the derived motion vector,
(mvbaseₓ,mvbase_{y}) represents the base motion vector, and (PicWidthEnh×PicHeightEnh) and (PicWidthBase×PicHeightBase) are the sizes of the enhancement and base images, respectively.
reference picture indices
QP value (used afterwards when applying the DBF onto the Base Mode prediction picture)

Each LCU of the enhancement image is thus organized regardless of the way the corresponding LCU in the base image has been encoded.

The prediction information derivation for a scaling ratio 1.5 aims at generating up-scaled prediction information that may be used later during the predictive coding of motion information. As explained the prediction information can be used in the construction of the Base Mode prediction image. The Base Mode prediction image quality highly depends on the accuracy of the prediction information used for its prediction.

FIG. 8B schematically illustrates the correspondence between each 4×4 enhancement coding unit (processing block) being considered, and the respective corresponding co-located spatial area in the base image in the case of a 1.5 scaling ratio. As can be seen, the corresponding co-located area in the base image may be fully contained within a coding unit (prediction unit) of the base layer, or may overlap two or more coding units of the base layer. This happens for enhancement CUs having coordinates (XCU, YCU) such that:

(XCU mod 3=1) or (YCU mod 3=1) (3)

In the first case in which the corresponding co-located area in the base image is fully contained within a coding unit of the base layer, the prediction information derivation for the considered 4×4 enhancement CU is simplified. It comprises obtaining the prediction information values of the corresponding base prediction unit within which the enhancement CU is fully contained, transforming the obtained prediction information values towards the resolution of the enhancement layer, and providing the considered 4×4 enhancement CU with the so-transformed prediction information.

In the second case where the corresponding co-located area in the base image overlaps, at least partially, each of a plurality of coding units of the base layer different approaches may be adopted. For example, co-located base area of current 4×4 enhancement coding unit (processing block) Y overlaps two coding units of the base image, and enhancement coding unit (processing block) Z overlaps four coding units of the base image.

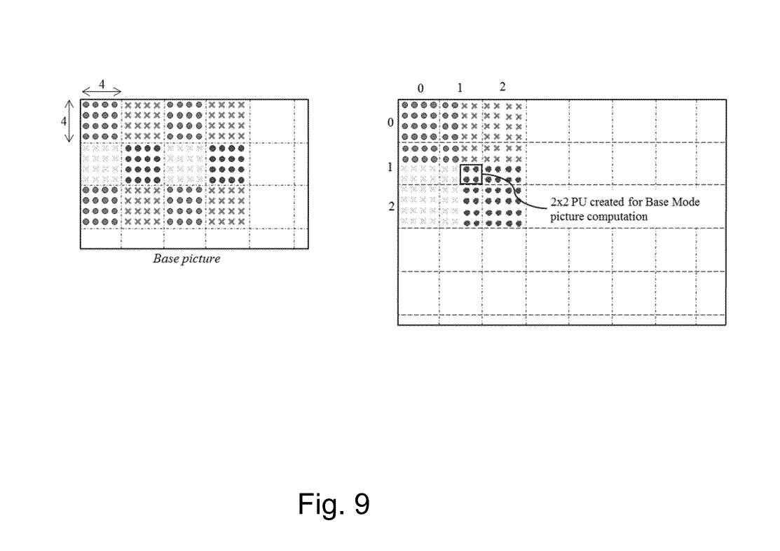

In one particular embodiment for these particular enhancement layer coding units overlapping a plurality of coding units of the base layer, each 4×4 enhancement CU is split into 2×2 Coding Units. Each 2×2 enhancement CU contained in a 4×4 enhancement CU then has a unique co-sited CU in the base image and inherits the prediction information coming from that co-located base image CU. For example, with reference to FIG. 9, the enhancement 4×4 CU with coordinates (1,1) inherits prediction data from 4 different elementary 4×4 CUs {(0,0); (0,1); (1,0); (1,1)} in the base image.

As a result of the prediction information up-sampling process for scaling ratios of 1.5 the Base Mode image construction process is able to apply motion compensated temporal prediction on 2×2 coding units and hence benefits from all the prediction information issued from the base layer.

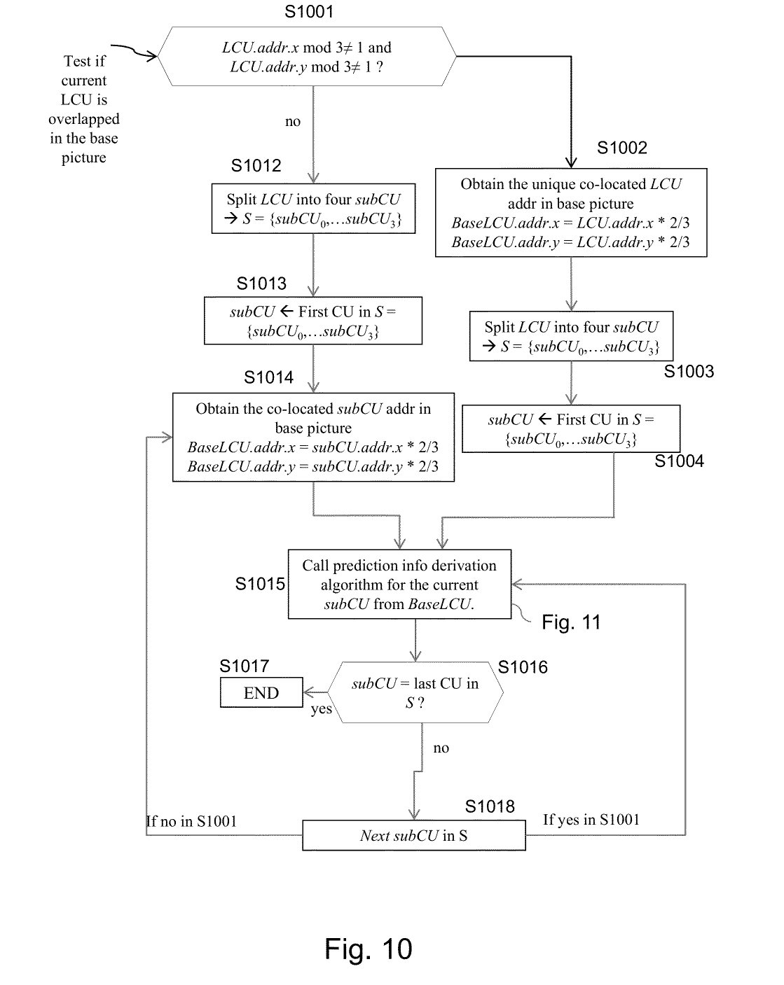

The method of determining where the prediction information is derived from, according to one particular embodiment of the invention is illustrated in the flow chart of FIG. 10.

The algorithm of FIG. 10 is repeatedly applied to each Largest Coding Unit LCU of the considered enhancement image. The first part of the algorithm is to determine, for a considered enhancement LCU, the one or more LCU's of the base image that are concerned by current enhancement LCU.

In step S1001, it is determined whether or not the current LCU in the enhancement image is fully covered by the spatial area that corresponds to an up-sampled Largest Coding Unit of the base layer. For example, LCU's 0 and 2 of FIG. 7(b) are fully covered by their respective co-located LCU in its up-scaled form, while LCU 1 is not fully covered by the spatial area corresponding to an up-sampled LCUs of the base layer, and is covered by spatial areas corresponding to parts of two up-sampled LCUs of the base layer.

This determination, based on expression (3) may be expressed by:

LCU.addr.x mod 301 and LCU.addr.y mod 3≠1 (4)

where LCU.addr.x is the coordinate x of the address of the considered LCU in the enhancement layer, LCU.addr.y is the coordinate y of the LCU in the enhancement layer, and mod (3) is the modulo operation providing the reminder of the division by 3.

Once the result of the above test is obtained, then the coder or decoder is able to known which LCU's and which coding units inside these LCU's should be considered in the next steps of the algorithm of FIG. 10.

In case of a positive test at step S1001, i.e. the current LCU of the base layer is fully covered by an up-sampled LCU of the base layer, then only one LCU in the base layer is concerned by current LCU in the enhancement image. This base layer LCU is determined as a function of the spatial coordinates of current enhancement layer LCU by the following expression:

BaseLCU.addr.x=LCU.addr.x*⅔ (5)

BaseLCU.addr.y=LCU.addr.y*⅔ (6)

where BaseLCU.addr.x represents the x co-ordinate of the spatially co-located coding unit of the base image and BaseLCU.addr.y represents the y co-ordinate of the spatially co-located coding unit of the base image. By virtue of the obtained coordinates of the base LCU, the raster scan index of that LCU can be obtained:

(BaseLCU.addr.x/LCUWidth)+(PicHeight/LCUWidth)*(BaseLCU.addry/LCUHeight) (7)

Then in step S1003 the current enhancement layer LCU is divided into four Coding Units of equal sizes, noted subCU, providing the set S of coding units:

S={subCU₀,subCU₁,subCU₂,subCU₃} (8)

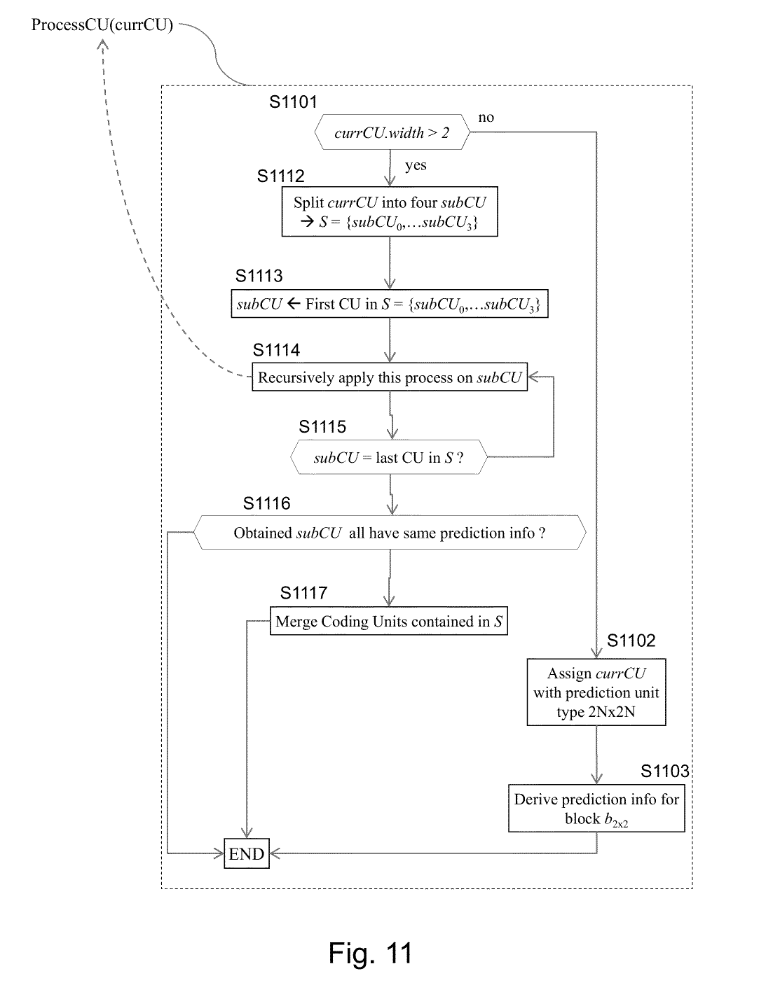

The next step of the algorithm of FIG. 10 involves a loop on each of these coding units. For each of these coding units, the algorithm of FIG. 11 is invoked at step S1015, in order to perform the prediction information derivation

In the case where the test of step S1001 leads to a negative result, i.e. i.e. the current LCU of the base layer is not fully covered by a single up-sampled LCU of the base layer, then this means the region of the base layer, spatially corresponding to the processing block (LCU) of the enhancement layer, overlaps several largest coding units (LCU) of the base layer in their up-scaled version. The algorithm of FIG. 10 then proceeds from step S1012 to step S1014. In step S1012 the LCU of size 64×64 of the enhancement layer is split into a set S of four sub coding units of size 32×32: S={subCU₀ . . . subCU₃}. In subsequent step S1013 the first sub coding unit subCU₀ is taken from the set S for further processing in step S1014.

Since the enhancement LCU is overlapped by at least two base LCU areas in their up-sampled version, the each subCU of the set S may belong to a different LCU of the base image. As a consequence, the next step of the algorithm of FIG. 10 involves determining, for each coding subCU in set S, the largest coding unit of the base layer that is concerned by that subCU. In step S1014 for each sub coding unit subCU of set S the collocated coding unit CU in the base layer is obtained:

BaseLCU.addr.x=subCU.addr.x*⅔ (9)

BaseLCU.addr.y=subLCU.addr.y*⅔ (10)

By virtue of the obtained coordinates of the base LCU, the raster scan index of that LCU is obtained:

(BaseLCU.addr.x/LCUWidth)+(PicHeight/LCUWidth)*(BaseLCU.addry/LCUHeight) (11)

In step S1015 the prediction information derivation algorithm of FIG. 11 is called in order to derive the prediction information for the current sub coding unit of step S1004 or step S1014 from the collocated largest coding unit LCU in the base image.

In step S1016 it is determined if the last sub coding unit of set S has been processed. The process returns to step S1014 or S1015 through step S1018 depending on the result of test S1001 so that all the sub coding units of set S are processed and ends in step S1017 when all the sub-coding units S have been processed for the enhancement processing block LCU.

The method of deriving the prediction information from the collocated largest coding unit of the base layer, in step S1015 of FIG. 10, is illustrated in the flow chart of FIG. 11.

In step S1101 it is determined if the current coding unit has a size greater than 2×2. If not the method proceeds to step S1102 where the current coding unit is assigned a prediction unit type 2N×2N and the prediction information is derived for the prediction unit b_{2×2} in step S1103.

Otherwise, if it is determined that the current coding unit has a size N×N greater than 2×2, for example 32×32, then, in step S1112 the current coding unit is split into a set S of four sub coding units of size N/2×N/2, 16×16 in the example: S={subCU₀ . . . subCU₃}. The first sub-coding unit subCU₀ is then selected for processing in step S1113 and each of the sub-processing units are looped through for processing in steps S1114 and S1115. Step S1114 involves a recursive call to the algorithm of FIG. 11 itself. Therefore, the algorithm of FIG. 11 is called with the current coding unit subCU as the input argument. The recursive call to the algorithm then aims at processing the coding units in their successively reduced size, until the minimal size 2×2 is reached.

When the test of step S1101 indicates that the input coding unit subCU to the algorithm of FIG. 11 has the minimal size 2×2, then an effective inter-layer prediction information derivation process takes place at steps S1102 and S1103. Step S1102 involves giving current coding unit subCU the prediction unit type 2N×2N, signifying that the considered coding unit is made of one single prediction unit. Then, step S1103 involves computing the prediction information that will be attributed to current coding unit subCU. To do so, the 4×4 block in the base picture that is co-located with the current coding unit is searched for in the base image, as a function of the scaling ratio, which in the present example is 1.5, that links the base and enhancement images. The prediction information of the found co-located 4×4 locks is then transformed towards the spatial resolution of the enhancement layer. Mostly, this involves multiplying the considered base motion vector by the scaling factor, 1.5. Other prediction information parameters may be assigned, without transformation, to the enhancement 2×2 coding unit.

When the inter-layer prediction information derivation is done, the algorithm of FIG. 11 ends and the method returns to the process that called it, i.e. step S1015 of FIG. 10 returning to step S1115 of the algorithm of FIG. 11, which loops to the next coding unit subCU to process at the considered recursive level. When all CU's at the considered recursive level are processed, then the algorithm of FIG. 11 proceeds to step S1116.

In step S1116 it is determined whether or not the sub coding units of the set S all have equal derived prediction information with respect to each other. If not the process ends. In the case where the prediction information is equal, then the coding units in set S are merged together in step S1117, in order to form one single coding unit of greater size. The merging step involves assigning a size to the merged CU that is twice the size of the initial coding units in width and height. In addition, with respect to derived motion vectors and other prediction information, the merged CU is given, the prediction information values that are commonly shared by the four coding units being merged. Once the merging step S1117 is done, the algorithm of FIG. 11 ends.

In another embodiment of the invention in the case where the coding unit of the enhancement layer overlap at least partially a plurality of spatially corresponding coding units of the base layer another approach may be taken. The overlapped coding units of the base layer may have equal or different prediction information values.
If the overlapped coding units of the base layer have equal prediction information (the case of enhancement block Z in FIG. 8B), then the enhancement 4×4 block Z is given that common prediction information, in its up-scaled form.
Otherwise if the prediction information of the overlapping prediction units differs between the overlapping coding units (the case of block Y in FIG. 8B), a choice is made on the base layer prediction information to be up-scaled to the enhancement layer. In this particular embodiment of the invention, the prediction information of the overlapped base PU that has the highest address, in terms of raster-scan ordering of 4×4 PUs in the base image, is selected and upscaled. i.e. in the case of coding unit Y the prediction information of the right PU covered by the base image area that spatially corresponds to current 4×4 block of the enhancement image is selected and in the case of coding unit Z the prediction information of the right-bottom 4×4 PU covered by the base image area that spatially corresponds to current 4×4 block of the enhancement image.

Typically the predictive coding of motion vectors in HEVC involves a list of motion vector predictors. These predictors correspond to the motion vectors of already coded PUs, among the spatial and temporal neighbouring PUs of a current PU. In the case of scalable coding, the list of motion vector predictors is enriched: the inter-layer derived motion vector for each enhancement PU is appended to the list of motion vector predictors for that PU.

To emphasize the efficiency of motion vector prediction, it is advantageous to have a list of motion vector predictor which is diversified in terms of motion vector predictor values. Therefore, one way to favour the diversity of motion vectors contained in such a list in the prediction of enhancement layer's motion vectors is to employ the motion vector of the right-bottom co-located PU in the base layer, when dealing with the prediction of an enhancement PU's motion vector(s).

In some embodiments of the invention each of the enhancement layer LCUs being processed may be systematically sub divided into coding units of size 2×2. In other embodiments of the invention only LCUs of the enhancement layer which overlap, at least partially, two or more up-sampled base layer LCUs are sub divided into coding units of size 2×2. In yet another embodiment only LCUs of the enhancement layer which overlap, at least partially, two or more up-sampled base layer LCUs are sub divided into smaller sized coded units up until they no longer overlap more than one up-sampled base layer LCU.

These latter embodiments are dedicated to the inter-layer derivation of prediction information in the case of a scaling factor 1.5 between the base and the enhancement layer.

In the case of SNR scalability the inter-layer derivation of prediction information is trivial. The derived prediction information corresponds to the prediction information of the coded base image.

Once the prediction information of the base image has been derived towards the spatial resolution of the enhancement layer, the derived prediction information can be used, in particular to construct the so-called base mode prediction picture. The base mode prediction picture is used later on in the prediction coding/decoding of the enhancement image.

The following depicts a construction of the base mode prediction image, in accordance with one or more embodiments of the invention. In the case of temporal residual data derivation for the computation of a Base Mode prediction image the temporal residual texture coded and decoded in the base layer is inherited from the base image, and is employed in the computation of a Base Mode prediction image. The inter-layer residual prediction used involves applying a bi-linear interpolation filter on each INTER prediction unit contained in the base image. This bi-linear interpolation of temporal residual is similar to that used in H.264/SVC.

According to an alternative embodiment, the residual data that is derived may be computed in a different way. Instead of taking the decoded residual data and up-sampling it, it may comprise re-calculating a new residual data block between reconstructed base layer images. Technically, the difference between the decoded residual data in the base mode prediction image and such a re-calculated residual would involve the following. The decoded residual data in the base mode prediction image results from the inverse quantization and then inverse transform applied to coding units in the base image. On the other hand, fully reconstructed base layer images have undergone some in-loop post-processing steps, which may include the de-blocking filter, Sample Adaptive Offset (SAO) and Adaptive Loop Filter (ALF). As a consequence, the reconstructed base layer images are of better quality in their fully post-processed versions, i.e. are closer to the original image than the image obtained just after inverse transform. Therefore, since the fully reconstructed base layer image are available in the proposed codec architecture, it is possible to re-calculate some residual blocks from fully reconstructed base layer images, as a function of the motion information of these base images. Such residual blocks differ from the residuals obtained after inverse transform, and can be advantageously employed to perform motion compensated temporal prediction during the construction of the Base Mode prediction image. This particular embodiment for inter-layer prediction of the residual data can be seen as analogous to the GRILP coding mode described previously in the scope of INTER prediction in the enhancement image, but is dedicated to the construction of the base mode prediction image

FIG. 12 schematically illustrates how a Base Mode prediction image is computed in accordance with one or more embodiments of the invention. This image is referred to as a Base Mode Image because it is predicted by means of the prediction information issued from the base layer 1201. The inputs to this process are as follows:
lists of reference images e.g. 1203 useful in the temporal prediction of the current enhancement image, i.e. the base mode prediction image 1200
prediction information e.g. temporal prediction 12A extracted from the base layer and re-sampled to the enhancement layer resolution. This corresponds to the prediction information resulting from the process of FIG. 11
temporal residual data issued from the base layer decoding, and re-sampled to the enhancement layer resolution e.g. inter-layer temporal residual prediction 12C
base layer reconstructed image 1204.

The Base Mode picture construction process comprises predicting each coding unit e.g. 1205 of the enhancement image 1200, conforming to the prediction modes and parameters inherited from the base layer.

The method proceeds as follows.
For each LCU 1205 in the current enhancement image 1200: obtain the up-sampled Coding Unit representation issued from the base layer
   For each CU contained in the current LCU
      For each prediction unit (PU) e.g. sub coding unit, in the current coding unit
         Predict current PU with its prediction information inherited from the base layer

The PU prediction step proceeds as follows. In the case where the corresponding base PU was Intra-coded e.g. base layer intra coded block 1206, then the current prediction unit of the base mode prediction image 1200 is predicted by the reconstructed base coding unit, re-sampled to the enhancement layer resolution 1207. In practice, the corresponding spatial area in the Intra BL prediction image is copied.

In the case of an INTER coded base coding unit, then the corresponding prediction unit in the enhancement layer is temporally predicted as well, by using the motion information inherited from the base layer. This means the reference image(s) in the enhancement layer that correspond to the same temporal position of the reference images(s) of the base coding unit are used. A motion compensation step 12B is applied by applying the motion vector 1210 inherited from the base layer onto these reference images. Finally, the up-sampled temporal residual data of the co-located base coding unit is applied onto the motion compensated enhancement PU, which provides the predicted PU in its final state.

Once this process has been applied on each PU in the enhancement image, a full “Base Mode” prediction image is available.

It may be noted that by virtue of the proposed base mode prediction image illustrated in FIG. 12, the base mode prediction mechanism employed in the proposed scalable codec has the following property.

For coding units of the enhancement image that are coded using the base mode, the data that is predicted is the texture data only. On the contrary, in the former H.264/SVC scalable video compression system, processing blocks (macroblocks) that were encoded using a base layer prediction mode were fully inferred from the base image, in terms of prediction information and macroblock (LCU) representation. For example, the macroblocks organization in terms of splitting macroblocks LCU into sub-macroblocks CU (sub processing blocks) 8×8, 16×8, 8×16 or 4×4 was imposed as a function of the way the underlying base macroblock was split. For instance, in the case of dyadic spatial scalability, if the underlying base macroblock was of type 4×4, then the corresponding enhancement macroblocks, if coded with the base mode, was split into four 8×8 sub-macroblocks.

On the contrary, in embodiments of the present invention, the coding structure chosen in the enhancement image is independent of the coding structure representations that were used in the base layer, including for enhancement coding units using a base layer prediction mode.

This technical result comes from the fact that the base mode prediction image is used as an intermediate step between the base layer and the enhancement layer coding. An enhancement coding unit that employs the base mode prediction type only makes use of the texture data contained in its co-located area in the base mode prediction picture, and no prediction data issued from the base layer. Once the base mode prediction image is obtained the base mode prediction type involved in the enhancement image coding ignores the prediction information of the base layer.

As a result, an enhancement coding unit that employs the base mode prediction type may spatially overlap several coding units of the base layer, which may have been encoded by different modes.

This decoupling property of the base mode prediction type makes it different from the base mode previously specified in the former H.264/SVC standard.

The following description presents a deblocking filtering step applied to the base mode prediction picture provided by the mechanisms of FIG. 12. The constructed base mode image is made up of a series of temporally and intra prediction units. These prediction units are derived from the base layer through the prediction information up-sampling process previously described with reference to FIGS. 7A and 7B. Therefore, these derived prediction units (PU's) have some prediction data which differs from one enhancement prediction unit to another. As can be appreciated, some blocking artefacts may appear at the boundaries between these prediction units. The blocking artefacts so-obtained in the base mode prediction image are even stronger than those of traditional coded/decoded image in standard video coding, since no prediction error data is added to the predicted blocks contained in it.

As a consequence, it is proposed in one particular embodiment of the invention, to apply a deblocking filtering process to the base mode prediction image. According to one embodiment of the invention, the deblocking filtering step may be applied to the boundaries of inter-layer derived prediction units. To do so, each LCU of the enhancement layer is de-blocked by considering the inter-layer derived CU structure associated with that LCU. The Quantization Parameter (QP) used during the Base Mode image de-blocking process is equal to the QP of the Co-located base CU of the CU currently being de-blocked. This QP value is obtained during the inter-layer CU derivation in accordance with embodiments of the invention.

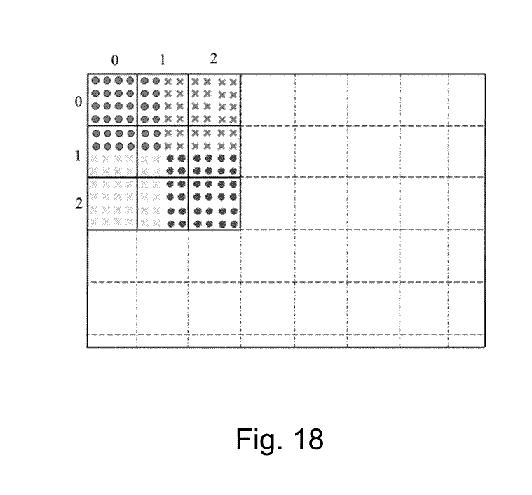

Finally, with respect to scalability ratio 1.5, the minimum CU considered during the de-blocking filtering step has a 4×4 size. This means the de-blocking does not process 2×2 blocks frontiers inside 4×4 coding units, as illustrated in FIG. 18.

In a further, more advanced, embodiment the de-blocking filter may also apply to the boundaries of inter-layer derived transform units. To do so, in the inter-layer derivation of prediction information, it is needed to additionally derive the transform unit organization from the base layer towards the spatial resolution of the enhancement layer.

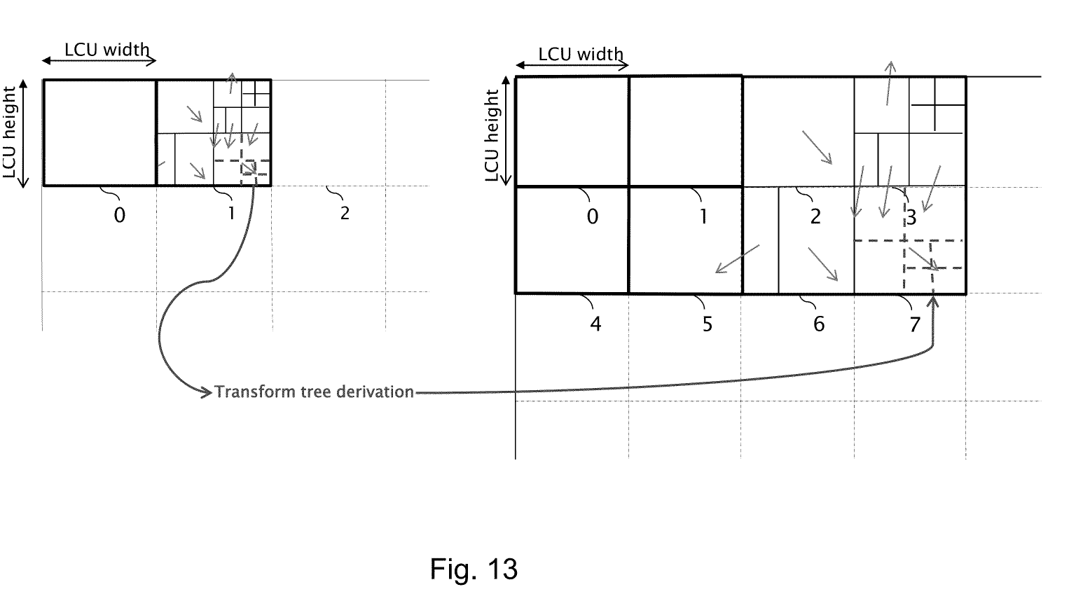

FIG. 13 illustrates an example of enriched inter-layer derivation of prediction information in the case of dyadic spatial scalability. The derivation process for enhancement LCUs has already been explained, concerning the derivation of coding unit quad-tree representation, prediction unit partition, and associated motion vector information. In addition, the derivation of transform unit splitting information is illustrated in FIG. 13. As can be seen, the transform unit splitting, also called transform tree in the HEVC standard consists in further dividing the coding units in a quad-tree manner, which provides so-called transform units. A transform unit specifies an elementary image area or block on which the DCT transform and quantization are actually performed during the HEVC coding process. Reciprocally, a transform unit is the elementary picture area where inverse DCT and inverse quantization are performed on the decoder side.

As illustrated by FIG. 13, the inter-layer derivation of a transform tree aims at providing an enhancement coding unit with a transform tree which is the same shape as the transform tree of the co-located base coding unit.

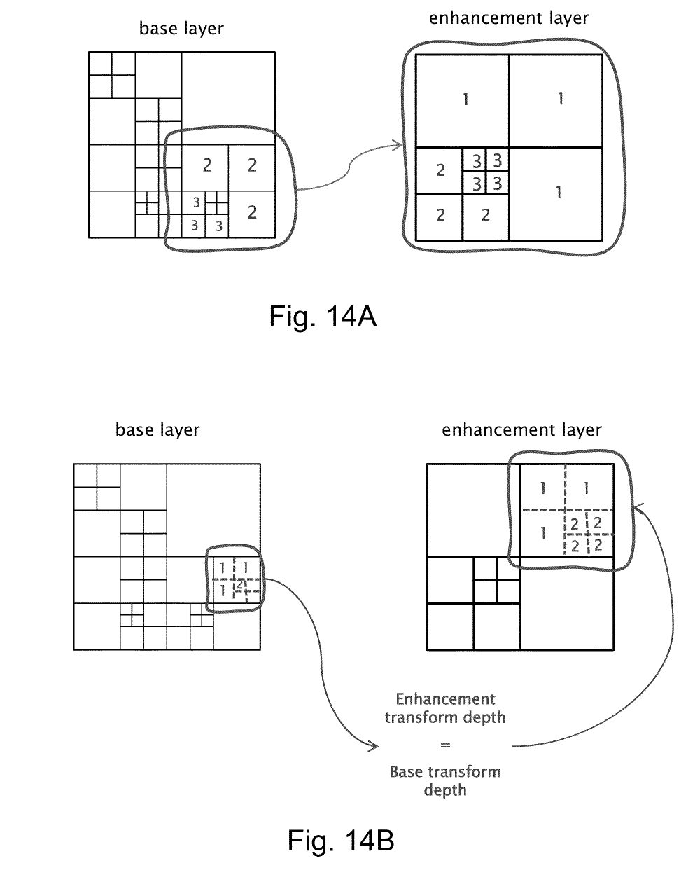

FIG. 14A and FIG. 14B depict how the inter-layer transform tree derivation proceeds, in one embodiment of this invention, in the dyadic spatial scalability case. FIG. 14A recalls the prediction information derivation process, applied to coding units, prediction units and motion vectors. In particular, the coding depths transformation from the base to the enhancement layer, in the case of dyadic spatial scalability, is shown. As can be seen, in this context, the derivation of the coding tree information consists in decreasing by one the depth value associated with each coding unit. With respect to base coding units that have a depth value equal to 0, hence have maximal size and correspond to an LCU, their corresponding enhancement coding units are also assigned the depth value 0.

FIG. 14b illustrates the way the transform tree is derived from the base layer towards the enhancement layer. In HEVC, the transform tree is a quad-tree embedded in each coding unit. Thus, each transform unit is fully specified by virtue of its relative depth. In other words, a transform unit with a zero depth has a size equal to the size of the coding unit it belongs to. In that case, the transform tree is made of a single transform unit.

The transform unit (TU) depth thus specifies the size of the considered TU relative to the size of the CU that it belongs to, as follows:

TU_{width}=CU_{width}*2^{-TUdepth}

TU_{height}=CU_{height}*2^{-TUdepth}

where (TU_{width}, TU_{height}) and (CU_{width}, CU_{height}) respectively represent size, in width and height, of the considered TU and CU, and TU_{depth} represents the TU depth.

As shown in FIG. 14b, to obtain the same transform tree depth in the enhancement layer as in the base layer, the TU derivation simply includes providing the enhancement coding units with the same transform tree representations as in the base layer.

Once the derived transform unit is obtained, then both the encoder and the decoder are able to apply the de-blocking filtering step onto the constructed base mode picture, according to the more advanced embodiment of this invention.

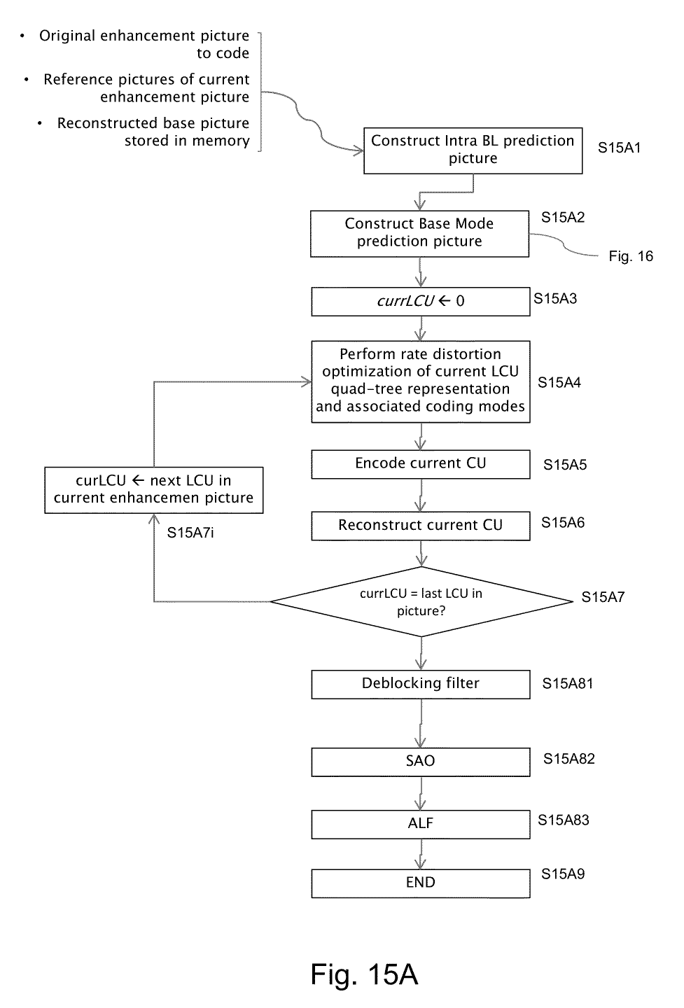

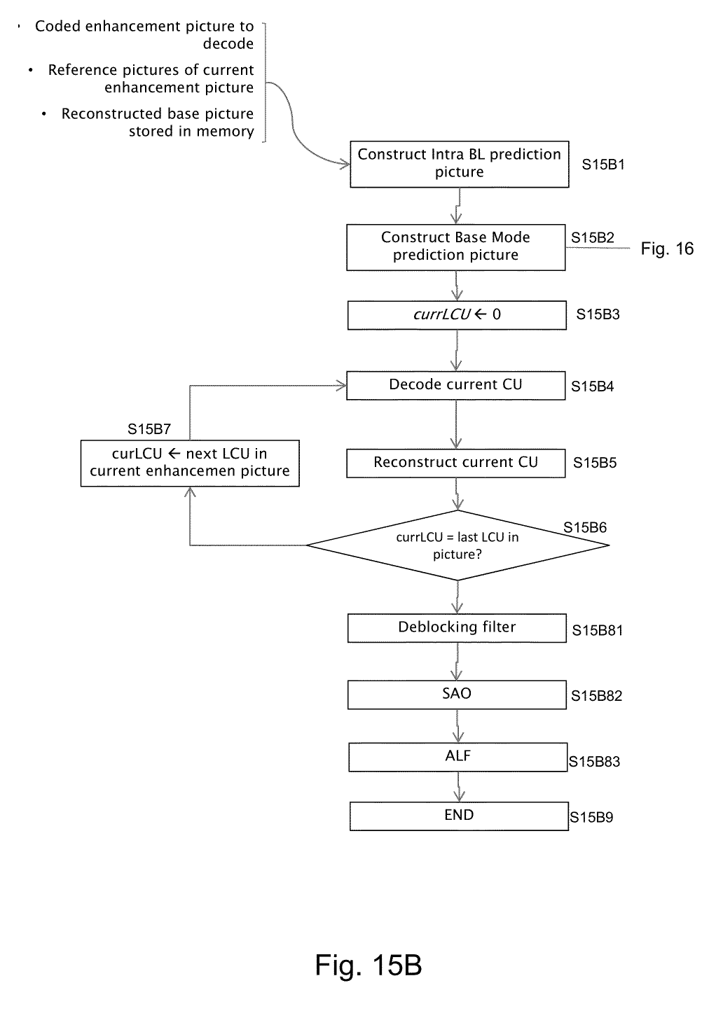

FIG. 15A is a flow chart illustrating an overall enhancement image coding algorithm, according to at least one embodiment of the invention. The inputs to this algorithm are the current enhancement image to be encoded, the reference images available in the enhancement layer for the temporal prediction of the current enhancement image, as well as the reconstructed base layer images available in the decoding image buffer of the base layer coding stage of the proposed scalable video codec.

The two first steps of the algorithm comprise computing the image data that will be used later to predict the coding units of the current enhancement image. In step S15A1 the so-called Intra BL prediction image is constructed through a spatial up-sampling of the base image of the current enhancement image. This up-sampled image will serve to compute the Intra BL prediction mode, already described with reference to FIGS. 5 and 6.

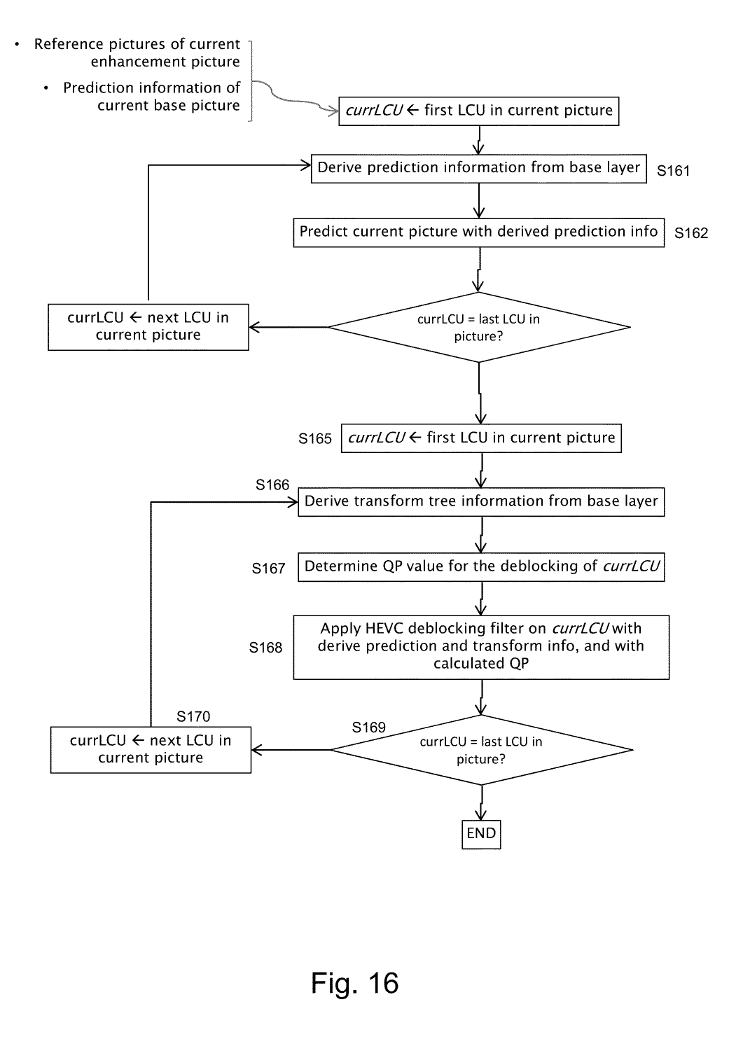

The next step S15A2 comprises constructing the base mode prediction image, according to one particular embodiment of this invention. The computation of this base mode prediction image will be described, with reference to FIG. 16.

Once the base mode prediction image is available in its de-blocked version, then the actual image coding process takes place.

This takes the form of a loop at step S15A3 on the Largest Coding Units of current enhancement image as illustrated in FIG. 15A. For each Largest Coding Unit, the following is performed. A rate distortion optimization process in step S15A4 jointly decides how to split the current LCU into coding units in a quad-tree fashion, as well as the coding mode used to encode each coding unit of the LCU. The coding mode selection includes the selection of the prediction unit partition for each coding unit, as well as the motion vector and the intra prediction direction where relevant. The transform tree is also rate distortion optimized for each CU during this coding tree optimization process.

Once all the LCU structure and coding modes have been selected then the encoder is able to perform the actual LCU coding step.

This coding in step S15A5 includes, for each CU, the computation of the residual data associated with each CU in it (according to the chosen prediction mode), and the transform, quantization and entropy coding of this residual data. The prediction information of each coding unit is also performed in this step.

Step S15A6 of the algorithm of FIG. 15A comprises reconstructing the current LCU, through the decoding of each CU contained in the LCU.

When the loop on each LCU of the enhancement image is done in step S15A7, then the current enhancement image is available in its decoded version.

The next steps applied to the current enhancement image are the post-filtering steps, which include the de-blocking filter S15A81, the SAO (Sample Adaptive Offset) S15A82 and ALF (Adaptive Loop Filter) S15A83.

In other embodiments, any of these in-loop post-filtering steps may be de-activated.

Once the in-loop post-processing is done for current enhancement image, the algorithm of FIG. 15A ends in step S15A9.

FIG. 15B illustrates an enhancement image decoding process corresponding to the enhancement image coding process of FIG. 15A thus performing reciprocal operations. This takes the form of the construction of the Intra BL and Base Mode prediction images exactly in the same way as on the encoder side in steps S15B1 and S15B2. Next, a loop on the LCU's of the enhancement image is performed insteps S15B3 to S15B6. Each enhancement LCU is entropy decoded in step S15B4, and undergoes inverse quantization and inverse transform of each CU contained in the LCU. Next, a CU reconstruction takes place in step S15B5. This involves adding each decoded residual data block issued from the decoding step to its associated prediction block.

Once the loop on LCUs is done, the same post-filtering operations (deblocking, SAO and ALF) are applied to the obtained reconstructed image in steps S15B81 to S15B83, in an identical manner as the encoder side. Then the algorithm of FIG. 15B ends in step S15B9.

FIG. 16 is a flow chart illustrating an algorithm used to construct a base mode prediction image in accordance with an embodiment of the invention. This algorithm is executed both on the encoder and on the decoder sides.

The inputs to this algorithm are the following ones.
prediction information 1601 contained in the coded image of the base layer that temporally coincides with current enhancement image.
reference images available in the enhancement layer during the encoding or decoding of current enhancement image.

The algorithm of FIG. 16 includes two main loops. The first loop performs the prediction of each enhancement LCU, using prediction information derived from the base layer. The second loop performs the de-blocking filtering of the base mode prediction image.

The first loop thus successively performs the following for each LCU of the current enhancement image. First, for each LCU currLCU, HEVC prediction information is derived in step S161 for that LCU, as a function of the prediction information associated with the co-located area in the base image. This takes the form of the prediction information up-sampling process previously explained with reference to FIGS. 7A and 7B. Once the derived prediction information is obtained, the next step consists in predicting a current LCU in step S163 using the derived prediction information. As already explained with reference to FIG. 12, this involves a loop over all the derived coding units contained in the current LCU. For each coding unit of the inter-layer predicted coding tree, an INTER or INTRA prediction is performed, according to the coding mode derived from the base layer. Here INTRA prediction consists in predicting the considered CU from its co-located area in the Intra BL prediction image. INTER prediction consists in a motion compensated temporal prediction of current coding unit, with the help of the motion information derived from the base layer for the considered CU.

Once each LCU of the enhancement image has been predicted with the inter-layer derived prediction information S164, the coder or decoder performs the de-blocking filtering of the base mode prediction image. To do so, a second loop on the enhancement picture's LCU is performed S165. For each LCU, noted currLCU, the transform tree is derived in step S166 for each CU of the LCU, according to a more advanced embodiment of this invention.

The following step S167 comprises obtaining a quantization parameter to use during the actual de-blocking filtering operation. In one embodiment, the QP used is equal to the QP that was used during the encoding of the base image of the current enhancement image. In another embodiment, the QP used during the encoding of current enhancement image may be considered. According to another embodiment, a mean between the two can be used. In yet a further embodiment, the enhancement image QP can be considered when de-blocking the boundaries of the derived coding units, while the QP of the base image can be employed when de-blocking the boundaries between adjacent transform units.

Once the QP used for the subsequent de-blocking filtering is obtained, this effective de-blocking filtering is applied in subsequent step S168. It is noted that the CBF parameter (flag indicated, for each coding unit, if it contains at least non-zero quantized coefficient) is forced to zero for each coding unit during the base mode image de-blocking filtering step.

Once the last LCU in current enhancement picture has been de-blocked in step S169 the algorithm of FIG. 16 ends. Otherwise, the algorithm considers the next LCU in the image as the current LCU to process, and loops to transform tree derivation step S166.

In another embodiment, the base mode image may be constructed and/or de-blocked only on a part of the whole enhancement image. In particular, this may be of interest on the decoder side. Indeed, only a part of the coding units may use the base mode prediction mode. It is possible to construct and/or de-block the base mode prediction texture data only for an image area that at least covers these coding units. Such image area may consist, in a given embodiment, in the spatial area co-located with current LCU being processed. The advantage of such approach would be to save some memory and complexity, as the motion compensated temporal prediction and/or de-blocking filtering is applied on a sub-part of the image.

According to one embodiment, such an approach with reduced memory and complexity takes place only on the decoder side, while the full base mode prediction picture is computed on the encoder side.

According to yet another embodiment, the partial base mode image computing is applied both on the encoder and on the decoder side.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of processing prediction information for at least part of an image of an enhancement layer of video data, the video data including the enhancement layer and a base layer of lower quality, the enhancement layer being composed of processing blocks and the base layer being composed of elementary units, the method comprising
deriving, for processing blocks of the enhancement layer, prediction information from prediction information of one or more spatially corresponding elementary units of the base layer;
constructing a prediction image corresponding to the enhancement image,
the prediction image being composed of prediction units, each processing block of the enhancement layer corresponding spatially to at least one prediction unit of the prediction image, wherein each prediction unit is predicted by applying a prediction mode using the prediction information derived from the base layer.

2. The method according to claim 1 further comprising applying de-blocking filtering to the constructed prediction image.

3. The method according to claim 2 wherein the de-blocking filtering is applied to the boundaries of the prediction units of the prediction image.

4. The method according to claim 2 further comprising deriving the organisation of transform units of the elementary units in the base layer towards the enhancement layer wherein the de-blocking filtering is applied to the boundaries of the transform units derived from the base layer.

5. The method according claim 1 wherein in the case where the elementary unit of the base layer corresponding to the processing block considered is Inter-coded then the prediction unit of the prediction image is temporally predicted using motion information derived from the said corresponding elementary unit of the base layer.

6. The method according to claim 5 wherein the prediction unit is temporally predicted further using temporal residual information from the corresponding elementary unit of the base layer.

7. The method according to claim 6 wherein the temporal residual information from the corresponding elementary prediction of the base layer corresponds to the decoded temporal residual of the elementary unit of the base layer.

8. The method according to claim 6 wherein the residual of the base prediction unit is computed between base layer images, as a function of the motion information of the base prediction unit.

9. The method according to claim 1 wherein the prediction information for a prediction unit is derived from at least one elementary unit of the base layer corresponding to the processing block of the enhancement layer.

10. The method according to claim 1 further comprising determining whether or not the region of the base layer, spatially corresponding to the processing block, is fully located within one elementary unit of the base layer; and
in the case where the region of the base layer spatially corresponding to the processing block is fully located within one elementary unit of the base layer, deriving prediction information for that processing block from the base layer prediction information of the said one elementary unit;
otherwise in the case where the region of the base layer spatially corresponding to the processing block overlaps, at least partially, each of a plurality of elementary units,
dividing the processing block into a plurality of sub-processing blocks, each of size N×N such that the region of the base layer spatially corresponding to each sub-processing block is wholly located within one elementary prediction unit of the base layer; and
deriving the prediction information for each sub-processing block from the base layer prediction information of the spatially corresponding elementary unit.

11. The method according to claim 1 further comprising determining whether or not the region of the base layer, spatially corresponding to the processing block, is fully located within one elementary unit of the base layer; and
in the case where a region of the base layer, spatially corresponding to the processing block, is fully located within one elementary unit, the prediction information for the processing block is derived from the base layer prediction information of said one elementary unit;
otherwise, in the case where a plurality of elementary units are at least partially located in the region of the base layer spatially corresponding to the processing block, the prediction information for the processing block is derived from the base layer prediction information of one of said elementary unit, selected according to the relative location of said one of said plurality of elementary units with respect to the other elementary units of said plurality of elementary units.

12. The method according to claim 1 further comprising determining whether or not the region of the base layer, spatially corresponding to the processing block, is fully located within one elementary unit of the base layer; and
in the case where a region of the base layer, spatially corresponding to the processing block, is fully located within one elementary unit, the prediction information for the processing block is derived from the base layer prediction information of said one elementary unit;
otherwise, in the case where a plurality of elementary units are at least partially located in the region of the base layer spatially corresponding to the processing block, the prediction information for the processing block is derived from the base layer prediction information of one of said elementary unit, selected such that the prediction information of the elementary unit providing the best diversity among motion information values associated with the said processing block is selected.

13. A method of encoding an enhancement image composed of processing blocks wherein each processing block is composed of at least one enhancement prediction unit, each enhancement prediction unit being predicted according to a prediction mode, from among a plurality of prediction modes including a prediction mode comprising predicting the texture data of the considered enhancement prediction unit from its co-located area within the prediction image constructed in accordance with claim 1.

14. A method of decoding an enhancement image composed of processing blocks wherein each processing block is composed of at least one enhancement prediction unit, each enhancement prediction unit being predicted according to a prediction mode, from among a plurality of prediction modes, said prediction mode being signalled in the coded video bit-stream, one of said plurality of prediction modes comprising predicting the texture data of the considered enhancement prediction unit from its co-located area within the prediction image constructed in accordance with claim 1.

15. The method according to claim 14 wherein the plurality of prediction modes further includes a motion compensated temporal prediction mode, for temporally predicting the enhancement prediction unit from a reference image of the enhancement layer.

16. The method according to claim 12 wherein the plurality of prediction modes further includes an interlayer prediction mode in which the enhancement prediction unit is predicted from a spatially corresponding region of reconstructed elementary units of the base layer.

17. The method according to claim 12 wherein in the case where the corresponding elementary unit of the base layer is Intra-coded then the enhancement prediction unit is predicted from the elementary unit reconstructed and resampled to the enhancement layer resolution

18. The method according to claim 1 wherein in the case of spatial scalability between the base layer and the enhancement layer, the prediction information is up-sampled from a level corresponding to the spatial resolution of the base layer to a level corresponding to the spatial resolution of the enhancement layer.

19. A device for processing prediction information for at least part of an image of an enhancement layer of video data, the video data including the enhancement layer and a base layer of lower quality, the enhancement layer being composed of processing blocks and the base layer being composed of elementary units, the device comprising
a prediction information derivation module for deriving, for processing blocks of the enhancement layer, prediction information from prediction information of one or more spatially corresponding elementary units of the base layer;
an image construction module for constructing a prediction image corresponding to the enhancement image,
the prediction image being composed of prediction units, each processing block of the enhancement layer corresponding spatially to at least one prediction unit of the prediction image, wherein the image construction module is operable to prediction each prediction unit by applying a prediction mode using the prediction information derived from the base layer.

20. A computer-readable storage medium storing instructions of a computer program for implementing a method according to claim 1.
